(19) United States
(12) Patent Application Publication
(10) Pub. No.: US 2025/0001907 A1
(43) Pub. Date: Jan. 2, 2025

(54) SEAT ASSEMBLY FOR VEHICLE

(71) Applicant: Yanfeng International Automotive Technology Co., Ltd., Novi, MI (US)

(72) Inventor: Kurt Seibold, Farmington Hills, MI (US)

(21) Appl. No.: 18/883,398

(22) Filed: Sep. 12, 2024

Related U.S. Application Data
(63) Continuation of application No. PCT/US2023/015549, filed on Mar. 17, 2023.
(60) Provisional application No. 63/321,322, filed on Mar. 18, 2022.

(51) Int. Cl. B60N 2/02

(52) U.S. Cl. CPC B60N 2/0284

(57) ABSTRACT

A vehicle seat assembly may comprise a base comprising a frame, a support comprising a spring element, a cushion and a pad. The cushion and pad may provide a deformable support surface. The support and/or spring element may be configured to move between retracted position and extended position. The support may be configured move between extended position and/or retracted position by movement of the spring element. The support may deflect to support an occupant. The support may be configured to increase seating surface area in movement from retracted position to extended position; the deformable support surface may be configured to provide a pressure distribution by variation of seating surface area. The pad may be supported by the spring element; the spring element may be wound to retract and unwound to extend. The cushion may provide a fulcrum for the support. The support may be configured to support a cushion assembly.

### CROSS-REFERENCE TO RELATED APPLICATIONS

The present application is a continuation of and incorporates by reference PCT/International Patent Application No. PCT/US/15549 titled “SEAT ASSEMBLY FOR A VEHICLE” filed Mar. 17, 2023, which claims priority to and incorporates by reference U.S. Provisional Patent Application No. 63/321,322 titled “COMPONENT FOR VEHICLE INTERIOR” filed Mar. 18, 2022.

The present application claims priority to and incorporates by reference in full the following patent applications: PCT/International Patent Application No. PCT/US/15549 titled “SEAT ASSEMBLY FOR A VEHICLE” filed Mar. 17, 2023; and U.S. Provisional Patent Application No. 63/321,322 titled “COMPONENT FOR VEHICLE INTERIOR” filed Mar. 18, 2022.

### FIELD

The present invention relates to seat assembly for a vehicle.

### BACKGROUND

It is known to provide a vehicle seat assembly comprising a seat comprising a back and a base/cushion comprising a cushion frame and a leg support.

It would be advantageous to provide a seat assembly for a vehicle comprising a base and a support coupled to a frame with a cushion and a pad movable relative to the base.

It would be advantageous to provide a seat assembly for a vehicle a comprising a support comprising a spring element movable to extend and retract.

It would be advantageous to provide a seat assembly for a vehicle comprising a base and a support comprising a spring element coupled to a frame with a cushion and a pad and movable relative to the base.

It would be advantageous to provide a seat assembly for a vehicle a comprising a support comprising a spring element configured to provide a deformable support surface for an occupant.

It would be advantageous to provide a seat assembly for a vehicle a comprising a support comprising a spring element integrated with a cushion assembly configured to provide a deformable support surface for an occupant.

It would be advantageous to provide a seat assembly for a vehicle a comprising a support comprising a moveable spring element integrated with a cushion assembly configured to provide a deformable support surface to facilitate enhance comfort for an occupant.

### SUMMARY

The present invention relates to a seat assembly for an occupant of a vehicle; the seat assembly may comprise a base comprising a frame and a support coupled to the frame comprising a spring element and a cushion and a pad on the support and movable relative to the base; the support may be configured for movement between an extended position and a retracted position; the cushion and the pad may be configured to provide a deformable support surface for the occupant; the pad may be configured to be supported by the spring element of the support; the pad may be configured to be extended from the base when the support may be in the extended position; the pad may be configured to be retracted toward the base when the support may be in the retracted position. The support may be configured to increase a seating surface area in movement from the retracted position to the extended position. The spring element may be configured to be wound to move the support toward the retracted position; the spring element may be configured to be unwound to move the support toward the extended position. The support may be configured to increase a seating surface area in movement from the retracted position to the extended position; the deformable support surface may be configured to provide a variable pressure distribution by variation of the seating surface area. The support may comprise a fulcrum; the fulcrum may be configured to shift as the support moves between the extended position and the retracted position. The deformable support surface may comprise a reactive surface configured to support the occupant; the support may be configured to communicate a reactive force through the pad and/or the cushion configured to support the occupant. The support may be configured provide a reactive surface configured to deflect to provide a reactive force with varying contact pressure to support the occupant; the reactive surface may be provided by the spring element and the cushion and the pad; the cushion may be configured to provide shape control for the reactive surface. The reactive surface may be in the extended shape when the pad may be in an extended position; the reactive surface may be in the retracted shape when the pad may be in a retracted position; the reactive surface may be moved toward the retracted shape when the support may be moved toward the retracted position by movement of the spring element. The pad may be configured to move relative to the cushion as the support moves between the retracted position and the extended position. The spring element may comprise a flexible panel. The spring element may comprise at least one of (a) a curved sheet spring and/or a curved sheet and/or a formed curved sheet; (b) a curved form and/or a curved shape and/or a pre-form shape; (c) a spring member and/or a spring strip and/or a segmented spring element; (d) a spring as a flexible panel between the cushion and the pad. The spring element may comprise a feature; the feature may comprise at least one of (a) a stiffener; (b) a set of features; (c) a set of stiffeners; (d) a set of recesses; (e) a set of transverse recesses; (f) a set of transverse recesses of varying length; (g) a set of ribs; (h) a set of ribs of varying length;. (i) a set of transverse ribs of varying length; (j) a feature configured to provide a stiffness of the spring element; (k) a set of features configured to provide a spring force for the spring element; (l) at least one of a recess and/or a recess at a front end and/or a recess configured to facilitate deflection of the spring element; (m) a set of stiffeners and a recess; (n) an attachment for a cover material. The spring element may comprise at least one of (a) a resin material; (b) a metal element; (c) a TPE material; (d) a substrate and a set of spring strips; (c) a wedge shape; (f) an elastomeric material; (g) a flexible panel; (h) a flexible panel comprising an elastomer; (i) a semi-rigid deformable flexible panel. The seat assembly may further comprise a cushion assembly comprising the cushion and the pad; the support may be configured to support the cushion assembly; the spring element may be within the cushion assembly; the frame may comprise a cushion frame configured to support the cushion assembly;. The pad may be at least partially coupled onto the spring element. The spring element may be provided in a default shape; the default shape may comprise a partially unwound shape; the spring element may be configured to be moved from the partially unwound shape toward a partially wound shape. The shape of the spring element may comprise a partially curved shape; further comprising a mechanism configured to alter the partially curved shape of the spring element between a partially extended shape and a partially retracted shape. The support may comprise a spring comprising a first end coupled to a top side of the cushion frame and a second end coupled to a bottom side of cushion frame. The spring element may comprise a base end and front end; the base end of the spring element may be coupled to the frame; the front end of the spring element may be coupled to the frame; the support may comprise a beam support supported at a base end and a front end. The seat assembly may further comprise a mechanism configured to adjust the support; the mechanism may comprise at least one of (a) a cable mechanism; (b) a cable drive mechanism; (c) an actuator; (d) a motor; (e) a drive mechanism comprising an actuator; (f) an actuator configured to pull a cable to straighten the support; (g) a mechanism configured to move the support between the retracted position and the extended position; (h) a actuator configured to move the support between the retracted position and the extended position; (i) a mechanism configured to move the support toward the retracted position; (j) a mechanism configured to wind the spring element toward the retracted position and to unwind the spring element toward the extended position; (k) a mechanism configured to move the support between a retracted position and an extended position by altering the shape of the spring element; (l) a mechanism configured to alter the curved shape of the spring element between a partially unwound shape and a partially wound shape.

The present invention relates to a seat assembly for an occupant of a vehicle; the seat assembly may comprise a base comprising a frame and a support coupled to the frame comprising a spring element and a cushion and a pad on the support and movable relative to the base; the support may be configured for movement between an extended position and a retracted position; the cushion and the pad may be configured to provide a deformable support surface for the occupant; the pad may be configured to be supported by the spring element of the support; the pad may be configured to be extended from the base when the support may be in the extended position; the pad may be configured to be retracted toward the base when the support may be in the retracted position. The extended position may comprise a default position for the support. The cushion may be configured to provide a fulcrum for the support. The spring element may be configured to be wound to move the support toward the retracted position; the spring element may be configured to be unwound to move the support toward the extended position. The support may be configured to deflect to support the occupant; the spring element may be configured to deflect. The deformable support surface may comprise a reactive surface configured to support the occupant; the support may be configured to provide the reactive surface configured to support the occupant. The support may be configured to communicate a reactive force through the pad and/or the cushion configured to support the occupant. The support may be configured to provide a reactive surface configured to deflect to provide a reactive force with varying contact pressure to support the occupant; the reactive surface may be provided by the spring element and the cushion and the pad. The support may be configured to provide a reactive surface configured to deflect to provide a reactive force to support the occupant; the cushion may be configured to provide shape control for the reactive surface. The deformable support surface may comprise a compound support surface configured to support the occupant; the compound support surface may comprise the support with the cushion and the pad to provide a variable pressure distribution by variation of the area of the support. The reactive surface may be in the extended shape when the pad may be in an extended position; the reactive surface may be in the retracted shape when the pad may be in a retracted position; the reactive surface may be moved toward the retracted shape when the support may be moved toward the retracted position by movement of the spring element. The reactive surface may be rolled toward the extended shape when the support may be moved toward the extended position by unwinding of the spring element. The spring element may comprise a flexible panel. The spring element may comprise at least one of (a) a curved sheet spring; (b) a curved sheet; (c) a formed curved sheet. The spring element may comprise at least one of (a) a curved form; (b) a curved shape; (c) a pre-form shape. The spring element may comprise a spring member and/or a spring strip and/or a segmented spring element. The spring element may comprise a feature; the feature may comprise at least one of (a) a stiffener; (b) a set of features; (c) a set of stiffeners; (d) a set of recesses; (e) a set of transverse recesses; (f) a set of transverse recesses of varying length; (g) a set of ribs; (h) a set of ribs of varying length;. (i) a set of transverse ribs of varying length; (j) a feature configured to provide a stiffness of the spring element; (k) a set of features configured to provide a spring force for the spring element; (l) at least one of a recess and/or a recess at a front end and/or a recess configured to facilitate deflection of the spring element; (m) a set of stiffeners and a recess; (n) an attachment for a cover material. The spring element may comprise at least one of (a) a resin material; (b) a metal element; (c) a TPE material; (d) a substrate and a set of spring strips; (e) a wedge shape. The support may be configured to be moved toward the retracted position by winding the spring element. The support may be configured to be moved toward the extended position by movement of the spring element. The seat assembly may further comprise a cushion assembly comprising the cushion and the pad; the support may be configured to support the cushion assembly; the spring element may be within the cushion assembly; the frame may comprise a cushion frame configured to support the cushion assembly. The cushion may comprise a feature configured to retain the spring element. The spring element may be coupled to the frame at a connector. The spring element may comprise a base end and front end; the base end of the spring element may be coupled to the frame; the front end of the spring element may be coupled to the frame. The support may comprise a beam support supported at a base end and a front end. The cushion may be configured to provide a shape control under the spring element of the support. The pad may be at least partially wrapped onto the spring element. The spring element may be provided in a default shape; the default shape may comprise a partially unwound shape; the spring element may be configured to be pulled from the partially unwound shape toward a partially wound shape. The shape of the spring element may comprise a partially curved shape; further comprising a mechanism configured to alter the partially curved shape of the spring element between a partially extended shape and a partially retracted shape. The support may be configured to increase a seating surface area in movement from the retracted position to the extended position. The support may comprise a fulcrum; the fulcrum may be configured to shift as the support moves between the extended position and the retracted position. The pad may be configured to deflect adjacent to the fulcrum. The support may comprise a spring comprising a first end coupled to a top side of the cushion frame and a second end coupled to a bottom side of cushion frame. The seat assembly may further comprises a mechanism configured to adjust the support; the mechanism may comprise at least one of (a) a cable mechanism; (b) a cable drive mechanism; (c) an actuator; (d) a motor; (c) a drive mechanism comprising an actuator; (f) an actuator configured to pull a cable to straighten the support; (g) a mechanism configured to move the support between the retracted position and the extended position; (h) a actuator configured to move the support between the retracted position and the extended position; (i) a mechanism configured to move the support toward the retracted position; (j) a mechanism configured to wind the spring element toward the retracted position and to unwind the spring element toward the extended position; (k) a mechanism configured to move the support between a retracted position and an extended position by altering the shape of the spring element; (l) a mechanism configured to alter the curved shape of the spring element between a partially unwound shape and a partially wound shape. The pad may be configured to move relative to the cushion as the support moves between the retracted position and the extended position. The seat assembly may further comprise a spring and a flexible panel between the cushion and the pad.

The present invention relates to a seat assembly for an occupant of a vehicle; the seat assembly may comprise a base comprising a frame and a seat back coupled to the base and a support coupled to the frame comprising a spring element and a cushion and a pad coupled to the support and movable relative to the base; the support may be configured for movement between an extended position and a retracted position; the cushion and the pad may be configured to provide a deformable support surface for the occupant. The support providing the deformable support surface may comprise a flexible panel; the flexible panel may comprise an elastomer to provide the spring element. The support may be configured to increase a seating surface area in movement from the retracted position to the extended position. The spring element may be configured to be wound to move the support toward the retracted position; the spring element may be configured to be unwound to move the support toward the extended position. The support may be configured to increase a seating surface area in movement from the retracted position to the extended position; the deformable support surface may be configured to provide a variable pressure distribution by variation of the seating surface area. The support may be configured to be moved toward the extended position by movement of the spring element. The seat assembly may further comprise a cushion assembly comprising the cushion and the pad; the support may be configured to support the cushion assembly; the spring element may be within the cushion assembly; the frame may comprise a cushion frame configured to support the cushion assembly. The cushion may comprise a feature configured to retain the spring element.

The present invention relates to a seat assembly for an occupant of a vehicle comprising a base comprising a frame; a support coupled to the frame comprising a spring element; a cushion; and a pad on the support and movable relative to the base. The support may be configured for movement between an extended position and a retracted position. The cushion and the pad may be configured to provide a deformable support surface for the occupant. The pad may be coupled to the support. The extended position may comprise a default position for the support. The support with the cushion and the pad may be configured to provide a deformable support surface for the occupant. The cushion may be coupled to the frame. The cushion may be configured to provide a fulcrum for the support. The cushion may be configured to provide a support structure for the spring element of the support. The pad may be configured to be supported by the spring element of the support. The pad may be configured to be extended from the base when the support is in the extended position. The pad may be configured to be retracted toward the base when the support is in the retracted position. The spring element may be configured to be wound to move the support toward the retracted position. The spring element may be configured to be unwound to move the support toward the extended position. The support may be configured to deflect to support the occupant; the spring element may be configured to deflect. The deformable support surface may comprise a reactive surface configured to support the occupant; the support may be configured to provide the reactive surface configured to support the occupant. The support may be configured to provide a reactive surface configured to provide a reactive force to support the occupant. The support may be configured to communicate a reactive force through the pad and/or the cushion configured to support the occupant. The support may be configured provide a reactive surface configured to deflect to provide a reactive force to support the occupant. The support may be configured provide a reactive surface configured to deflect to provide a reactive force with varying contact pressure to support the occupant; the reactive surface may be provided by the spring element and the cushion and the pad. The support may be configured provide a reactive surface configured to deflect to provide a reactive force to support the occupant; the cushion may be configured to provide shape control for the reactive surface. The deformable support surface may comprise a compound support surface configured to support the occupant; the compound support surface may comprise the support with the cushion and the pad to provide a variable pressure distribution by variation of the shape of the support. The compound support surface may comprise the support with the cushion and the pad to provide a variable pressure distribution by variation of the shape of the support with an adjuster comprising an operator control and a mechanism. The compound support surface may comprise the support with the cushion and the pad to provide a selectable pressure distribution by selective variation of the shape of the support with an adjuster comprising an operator control and a mechanism. The reactive surface may comprise an extended shape and a retracted shape. The reactive surface may be in the extended shape when the pad is in an extended position; the reactive surface may be in the retracted shape when the pad is in a retracted position; the reactive surface may be moved toward the retracted shape when the support is moved toward the retracted position by movement of the spring element. The reactive surface may be rolled toward the extended shape when the support is moved toward the extended position by unwinding of the spring element. The spring element may comprise a flexible panel. The spring element may comprise at least one of (a) a curved sheet spring; (b) a curved sheet; (c) a formed curved sheet. The spring element may comprise at least one of (a) a curved form; (b) a curved shape. The spring element may comprise a pre-form shape. The spring element may comprise a spring member. The spring element may comprise a spring strip. The spring element may comprise a segmented spring element. The support may comprise a feature. The spring element may comprise a feature. The feature may comprise at least one of (a) a stiffener; (b) a set of features; (c) a set of stiffeners; (d) a set of recesses; (c) a set of transverse recesses; (f) a set of transverse recesses of varying length; (g) a set of ribs; (h) a set of ribs of varying length. The feature may comprise a set of transverse ribs of varying length. The feature may be configured to provide a stiffness of the spring element. The feature may comprise a set of features configured to provide a spring force for the spring element. The feature may comprise at least one of (a) a recess; (b) a recess at a front end; (c) a recess configured to facilitate deflection of the spring element. The feature may comprise a set of stiffeners and a recess. The feature may comprise an attachment for a cover material. The spring element may comprise a wedge shape. The spring element may comprise at least one of (a) a resin material; (b) a metal element; (c) a TPE material. The spring element may comprise a substrate and a set of spring strips. The support may be configured to be moved toward the retracted position by winding the spring element. The support may be configured to be moved toward the extended position by movement of the spring element. The seat assembly may comprise a cushion assembly comprising the cushion and the pad. The cushion and pad may be configured to provide an interface within the cushion assembly; the pad may be configured to fit with the cushion at the interface. The support may be configured to support the cushion assembly. The spring element may be within the cushion assembly. The frame may comprise a cushion frame configured to support the cushion assembly. The cushion may comprise a slot; the spring element may be in the slot. The spring element may be in the slot adjacent a connector to the frame. The cushion assembly may comprise a slot; the spring element may be in the slot. The support may be coupled to the frame. The support may comprise the spring element and a set of mounting brackets; the support may be connected to the frame at the set of mounting brackets. The support may comprise a base end and a front end. The spring element of the support may be configured to be supported at a base end and a front end. The spring element may be coupled to the frame. The spring element may be coupled to the frame at a connector. The connector may comprise a bracket. The spring element may be coupled to the frame by at least one of (a) a bracket; (b) a mounting flange; (c) a clip; (d) a hook. The spring element may comprise a base end and front end; the base end of the spring element may be coupled to the frame; the front end of the spring element may be coupled to the frame. The front end of the spring element may be coupled to the frame by a clip. The front end of the spring element may be pivotally coupled to the frame at a hinge; the base end of the spring element may be coupled to the frame by a bracket. The support may comprise a beam support supported at a base end and a front end. The support may comprise a fulcrum. The support may comprise a fulcrum within the cushion. The support may comprise at least one of (a) a fulcrum between a base end and a front end; (b) a fulcrum for the spring element between the base end and the front end; (c) a fulcrum comprising a support point for the spring element. The cushion and the pad may be configured to provide an interface; the interface may be provided adjacent to a fulcrum for the spring element; the cushion may be configured to compress adjacent to the fulcrum. The cushion may be configured to provide a stop for the support. The cushion may be configured to provide a shape control for the support. The cushion may be configured to provide a shape control under the spring element of the support. The pad may be configured to deflect adjacent to the fulcrum. The pad may be at least partially wrapped onto the spring element. The cushion may comprise a foam pad; the pad may comprise a foam pad. The support may comprise at least one of (a) a cushion extender; (b) a leg support. The spring element may be provided in a curved shape. The spring element may be provided in a default shape; the default shape may comprise a partially unwound shape; the spring element may be configured to be pulled from the partially unwound shape toward a partially wound shape. A shape of the spring element may be a curved shape. The seat assembly may comprise a mechanism configured to alter the curved shape of the spring element between a partially unwound shape and a partially wound shape. The seat assembly may comprise a mechanism configured to move the support toward the retracted position. The seat assembly may comprise a mechanism configured to wind the spring element toward the retracted position and to unwind the spring element toward the extended position. The seat assembly may comprise a mechanism configured to move the support between a retracted position and an extended position by altering the shape of the spring element. The seat assembly may comprise a mechanism configured to move the support between the retracted position and the extended position. The mechanism may comprise at least one of (a) a cable drive mechanism; (b) an actuator; (c) a motor; (d) a drive mechanism. The mechanism may comprise a cable with a plug coupled to the support; the cable may be configured to move the support toward the retracted position. The spring element may be provided in an extended position; the mechanism may be configured to wind the spring element toward the retracted position; the mechanism may be configured to unwind the spring element toward the extended position.

The present invention relates to a seat assembly for an occupant of a vehicle comprising a base comprising a frame; a support coupled to the frame comprising a spring element; a cushion; and a pad coupled to the support and movable relative to the base. The support may be configured for movement between an extended position and a retracted position. The cushion and the pad may be configured to provide a deformable support surface for the occupant. The extended position may comprise a default position for the support. The support with the cushion and the pad may be configured to provide a deformable support surface for the occupant. The cushion may be coupled to the frame. The cushion may be configured to provide a fulcrum for the support. The cushion may be configured to provide a support structure for the spring element of the support. The pad may be configured to be supported by the support. The pad may be configured to be supported by the spring element of the support. The pad may be configured to be extended from the base when the support is in the extended position. The pad may be configured to be retracted toward the base when the support is in the retracted position. The extended position may comprise a default position for the pad. The spring element may be configured to be wound to move the support toward the retracted position. The spring element may be configured to be unwound to move the support toward the extended position. The spring element may be configured to be pulled toward the retracted position. The support may be configured to deflect to support the occupant. The spring element may be configured to deflect. The support may be configured to facilitate deflection of the pad. The support may be configured to facilitate flexure of the pad. The support may be configured to reduce bending of the pad. The deformable support surface may comprise a reactive surface configured to support the occupant. The support may be configured to provide the reactive surface configured to support the occupant. The support may be configured to provide a reactive surface configured to provide a reactive force to support the occupant. The support may be configured to provide a reactive surface configured to provide a distributed reactive force to support the occupant. The support may be configured to communicate a reactive force configured to support the occupant. The support may be configured to communicate a reactive force through the pad configured to support the occupant. The support may be configured to communicate a reactive force through the cushion configured to support the occupant. The support may be configured to provide a reactive surface configured to deflect to provide a reactive force to support the occupant. The support may be configured to provide a reactive surface configured to deflect to provide a reactive force to support the occupant. The support may be configured to provide a reactive surface configured to deflect to provide a reactive force with varying contact pressure to support the occupant. The reactive surface may be provided by the spring element and the cushion and the pad. The support may be configured to provide a reactive surface configured to deflect to provide a reactive force to support the occupant; the cushion may be configured to provide shape control for the reactive surface. The deformable support surface may comprise a compound support surface configured to support the occupant. The compound support surface may comprise the support with the cushion and the pad. The compound support surface may comprise the support with the cushion and the pad to provide a variable pressure distribution. The compound support surface may comprise the support with the cushion and the pad to provide a variable pressure distribution by variation of the shape of the support. The compound support surface may comprise the support with the cushion and the pad to provide a variable pressure distribution by variation of the shape of the support with an adjuster. The compound support surface may comprise the support with the cushion and the pad to provide a variable pressure distribution by variation of the shape of the support with an adjuster comprising an operator control and a mechanism. The compound support surface may comprise the support with the cushion and the pad to provide a selectable pressure distribution by selective variation of the shape of the support with an adjuster comprising an operator control and a mechanism. The reactive surface may comprise an extended shape and a retracted shape. The reactive surface may be in the extended shape when the support is in the extended position. The reactive surface may be in the retracted shape when the support is in the retracted position. The reactive surface may be in the extended shape when the pad is in an extended position. The reactive surface may be in the retracted shape when the pad is in a retracted position. The reactive surface may be moved toward the retracted shape when the support is moved toward the retracted position. The reactive surface may be moved toward the retracted shape when the support is moved toward the retracted position by movement of the spring element. The reactive surface may be moved toward the retracted shape when the support is moved toward the retracted position by winding of the spring element. The reactive surface may be rolled toward the extended shape when the support is moved toward the extended position by unwinding of the spring element. The spring element may comprise a flexible panel. The flexible panel may comprise a sheet spring. The spring element may comprise a sheet spring. The spring element may comprise a curved sheet spring. The spring element may comprise a curved sheet. The spring element may comprise a formed curved sheet. The spring element may comprise a curved form. The spring element may comprise a curved shape. The spring element may comprise a pre-form shape. The spring element may comprise a spring member. The spring element may comprise a set of spring members. The spring element may comprise a spring. The spring element may comprise a spring strip. The spring element may comprise a segmented spring element. The support may comprise a feature. The spring element may comprise a feature. The feature may comprise a stiffener. The feature may comprise a set of features. The feature may comprise a set of stiffeners. The feature may comprise a set of recesses. The feature may comprise a set of transverse recesses. The feature may comprise a set of transverse recesses of varying length. The feature may comprise a set of ribs. The feature may comprise a set of ribs of varying length. The feature may comprise a set of transverse ribs of varying length. The feature may be configured to provide a stiffness of the spring element. The feature may be configured to provide a spring force for the spring element. The feature may comprise a set of features configured to provide a spring force for the spring element. The feature may comprise a recess. The feature may comprise a recess at a front end. The feature may comprise a recess configured to facilitate deflection of the spring element. The feature may comprise a set of stiffeners and a recess. The feature may comprise an attachment for a cover material. The spring element may comprise a wedge shape. The spring element may comprise a resin material. The spring element may comprise a metal element. The spring element may comprise a TPE material. The spring element may comprise a substrate. The spring element may comprise the substrate and a set of springs. The set of springs may comprise a set of spring strips. The support may be provided in an extended position when the spring element is in a default state. The support may be configured to be moved toward the retracted position by movement of the spring element. The support may be configured to be moved toward the retracted position by winding the spring element. The support may be configured to be moved toward the extended position by movement of the spring element. The support may be configured to be moved toward the extended position by unwinding the spring element. The support may be provided in the extended position with the spring element moved toward an unwound state. The support may be configured to move toward the retracted position with the spring element moved toward a wound state. The seat assembly may comprise a cushion assembly comprising the cushion and the pad. The cushion and pad may be configured to provide an interface within the cushion assembly. The pad may be configured to fit with the cushion at the interface. A surface of the pad may be configured to fit with a surface of the cushion at the interface. The support may be configured to support the cushion assembly. The spring element may be within the cushion assembly. The frame may comprise a cushion frame. The cushion frame may be configured to support the cushion assembly. The frame may comprise a pan. The support may be within the frame. The cushion may comprise a base pad. The support may be coupled to the frame. The support may comprise the spring element and a set of mounting brackets. The support may be connected to the frame at the set of mounting brackets. The support may comprise a base end and a front end. The spring element of the support may be configured to be supported at a base end and a front end. The support may be coupled to the frame by a set of tabs. The support may be coupled to the frame by a clip arrangement. The spring element of the support may be coupled to the frame by a clip arrangement. The spring element may be coupled to the frame. The spring element may be coupled to the frame by a bracket. The spring element may be coupled to the frame by a mounting flange. The spring element may be coupled to the frame by a clip. The spring element may be coupled to the frame by a hook. The spring element may comprise a base end and front end. The base end of the spring element may be coupled to the frame. The front end of the spring element may be coupled to the frame. The front end of the spring element may be coupled to the frame by a clip. The front end of the spring element may be pivotally coupled to the frame by a clip. The front end of the spring element may be pivotally coupled to the frame at a hinge. The base end of the spring element may be coupled to the frame by a bracket. The base end of the spring element may be coupled to the frame by a mounting flange. The support may comprise a beam support. The beam support may be supported at a base end and a front end. The support may comprise a fulcrum. The support may comprise a fulcrum within the cushion. The support may comprise a fulcrum between a base end and a front end. The support may comprise a fulcrum for the spring element between the base end and the front end. The fulcrum may comprise a support point for the spring element. The cushion and pad may be configured to provide an interface. The interface may be provided adjacent to a fulcrum for the spring element. The cushion may be configured to compress adjacent to the fulcrum. The cushion may be configured to provide a stop for the support. The cushion may be configured to provide a shape control for the support. The cushion may be configured to provide a shape control under the spring element of the support. The pad may be configured to deflect adjacent to the fulcrum. The pad may be configured to cover the spring element. The pad may be at least partially wrapped onto the spring element. The cushion may comprise a foam pad. The pad may comprise a foam pad. The pad may comprise a continuous foam pad. The support may comprise an extender. The support may comprise a cushion extender. The support may comprise a leg support. The support may comprise a deformable support. The support may comprise a support frame coupled to the frame of the base. The support may comprise a cantilever structure. The spring element of the support may be configured to be supported at a base end and a front end. The spring element may be provided in a shape. The shape may comprise a curved shape. The shape may comprise a partially wound shape. The shape may comprise a partially unwound shape. The shape may comprise a default shape; the default shape may comprise the partially unwound shape. The spring element may be configured to be pulled from the partially unwound shape toward the partially wound shape. The seat assembly may comprise a mechanism configured to alter the shape of the spring element. The seat assembly may comprise a mechanism configured to alter the shape of the spring element between a partially unwound shape and a partially wound shape. The shape of the spring element may comprise a curved shape; the seat assembly may comprise a mechanism configured to alter the curved shape of the spring element between a partially unwound shape and a partially wound shape. The seat assembly may comprise a mechanism configured to move the support toward the retracted position. The seat assembly may comprise a mechanism configured to wind the spring element toward the retracted position. The seat assembly may comprise a mechanism configured to unwind the spring element toward the extended position. The seat assembly may comprise a mechanism configured to move the support between a retracted position and an extended position by altering the shape of the spring element. The seat assembly may comprise a mechanism configured to move the support between a retracted position and an extended position by altering the shape of the spring element. The seat assembly may comprise a mechanism configured to move the support toward an extended position. The seat assembly may comprise a mechanism configured to move the support between a retracted position and an extended position. The seat assembly may comprise a mechanism configured to move the support toward an extended position. The seat assembly may comprise an operator control for the mechanism. The mechanism may comprise a cable drive mechanism. The mechanism may comprise a cable coupled to the support. The mechanism may comprise an actuator. The actuator may comprise a motor. The actuator may comprise a drive mechanism. The actuator may comprise a screw drive. The mechanism may comprise a cable with a plug coupled to the support; the cable may be configured to move the support toward a retracted position. The cable may be configured to pull the spring element toward a retracted position. The spring element may be provided in an extended position. The spring element may be provided in an extended position; the mechanism may be configured to move the spring element toward the retracted position. The spring element may be provided in an extended position; the mechanism may be configured to wind the spring element toward the retracted position. The spring element may be provided in an extended position; the mechanism may be configured to unwind the spring element toward the extended position. The base may comprise a chassis. The chassis may be configured to be movable on a track system.

The present invention relates to a seat for a vehicle comprising a back assembly and a cushion assembly. The cushion assembly may comprise a cushion frame and a support. The support may be configured to move between a retracted position and an extended position. The support may comprise a top end coupled to a top side of the cushion frame and a bottom end coupled to a bottom side of cushion frame. When the support moves between the retracted position and the extended position the support may be configured to pivot about at least one of (a) the top end of the support; (b) the bottom end of the support. The support may be configured to deform as the support pivots about the at least one of (a) the top end of the support; (b) the bottom end of the support. The top end of the support is fixed to the top side of the cushion frame to prevent translation of the top end of the support; the bottom end of the support is fixed to the bottom side of cushion frame to prevent translation of the bottom end of the support. The support may be biased in the extended position. The support may be at least one of (a) stressed in the extended position; (b) loaded in the extended position. The support may be at least one of (a) stressed in the retracted position; (b) loaded in the retracted position. When the support is assembled to the cushion frame, the support is at least one of (a) pre-stressed; (b) pre-loaded. The support may be configured to increase a seating surface area in movement from the retracted position to the extended position. The support may be configured to rotate about the cushion frame. The support may comprise a first shape when in the retracted position and a second shape when in the extended position. The first shape may comprise a first arc length and the second shape may comprise a second arc length greater than the first are length. The first shape may comprise a curved shape; the second shape may comprise a straightened shape. The first shape may conform to a shape of the cushion frame. The first shape may comprise a wound shape and the second shape may comprise an unwound shape. The first shape may extend forward of the cushion frame; the second shape may be tucked under the cushion frame. The retracted position may comprise a lowered position and the extended position may comprise a raised position. The support may be configured to raise in movement from the retracted position to the extended position. The support may be configured to collapse in movement from the extended position to the retracted position. The support may be configured to provide a first thigh angle when in the retracted position and a second thigh angle when in the extended position. The second thigh angle may be greater than the first thigh angle. The support may be configured to provide a first cushion exit point when in the retracted position and a second cushion exit point when in the extended position. The support may be configured to wrap around the cushion frame. The support may comprise a cantilever relative to the cushion frame. The cushion frame may comprise a stop. The support may be configured to deflect against the stop. The support may be configured to wrap around the stop when in the retracted position. The support may be configured to flex when the seat is occupied. The support may be configured to apply a tensile force to the cushion frame when the support is in the extended position and the seat is occupied. The support may be configured to apply a compressive force to the cushion frame when the support is in the retracted position and the seat is occupied. The support may comprise a fulcrum; the fulcrum may be configured to shift as the support moves between the extended position and the retracted position. The support may comprise a compliant panel. The support may comprise a deformable panel. The support may comprise a TPE material. The support may comprise a spring comprising a first end coupled to a top side of the cushion frame and a second end coupled to a bottom side of cushion frame. The spring may be wound about the cushion frame when installed to the cushion frame. The spring may comprise a set of springs. The spring may comprise a spring steel material. The spring may be configured to wind and unwind. The seat may comprise a cable configured to at least one of (a) deform the spring; (b) pull the spring to move the support toward the retracted position. The cable may be coupled to the spring below the cushion frame between the first end of the spring and the second end of the spring. The seat may comprise a cable configured to provide a force to the spring (a) to pivot the first end relative to the cushion frame and (b) to pivot the second end relative to the cushion frame. The support may comprise a spring coupled to a panel. The panel may be molded on the spring. The seat may comprise a mechanism configured to adjust the support. The mechanism may comprise a cable mechanism. The mechanism may comprise an actuator. The actuator may be configured to pull a cable to move the support toward the extended position. The actuator may be configured to pull a cable to straighten the support. The actuator may comprise a screw drive. The actuator may comprise a motor. The seat may comprise a pad. The pad may comprise a foam. The pad may be configured to move relative to the cushion as the support moves between the retracted position and the extended position. The cushion may be fixed to the cushion frame; the pad may be configured to move above the cushion relative to the cushion frame as the support moves between the retracted position and the extended position. The seat may comprise a spring between the cushion and the pad. The seat may comprise at least one of (a) a panel between the cushion and the pad; (b) a suspension mat between the cushion and the pad. The seat may comprise a spring and a flexible panel between the cushion and the pad.

The present invention relates to a seat assembly for an occupant of a vehicle comprising a base comprising a frame; a support coupled to the frame comprising a spring element; a cushion supported by the frame; and a pad coupled to the support and movable relative to the base. The support may be configured for movement of the pad between an extended position and a retracted position.

The present invention relates to a seat assembly for an occupant of a vehicle comprising a base comprising a frame; a seat back coupled to the base; a support coupled to the frame comprising a spring element; a cushion supported by the frame; and a pad coupled to the support and movable relative to the base. The support may be configured for movement of the pad between an extended position and a retracted position.

The present invention relates to a seat assembly for an occupant of a vehicle comprising a base comprising a frame; a seat back coupled to the base; a support coupled to the frame comprising a spring element; a cushion; and a pad coupled to the support and movable relative to the base. The support may be configured for movement between an extended position and a retracted position. The cushion and the pad may be configured to provide a deformable support surface for the occupant.

The present invention relates to a seat assembly for an occupant of a vehicle comprising a base comprising a frame; a support coupled to the frame comprising a spring element; a cushion; and a pad coupled to the support and movable relative to the base. The support may be configured for movement between an extended position and a retracted position. The support and the cushion and the pad may be configured to provide a deformable support surface for the occupant.

The present invention relates to a seat for a vehicle comprising a back and a cushion. The cushion may comprise a cushion frame and a leg support. The leg support may be configured to move between a retracted position and an extended position. The leg support may comprise a top end coupled to a top side of the cushion frame and a bottom end coupled to a bottom side of cushion frame. When the leg support moves between the retracted position and the extended position the leg support may be configured to pivot about at least one of (a) the top end of the leg support; (b) the bottom end of the leg support. The leg support may be configured to deform as the leg support pivots about the at least one of (a) the top end of the leg support; (b) the bottom end of the leg support. The top end of the leg support may be fixed to the top side of the cushion frame to prevent translation of the top end of the leg support; the bottom end of the leg support may be fixed to the bottom side of cushion frame to prevent translation of the bottom end of the leg support. The leg support may be biased in the extended position. The leg support may be at least one of (a) stressed in the extended position; (b) loaded in the extended position. The leg support may be at least one of (a) stressed in the retracted position; (b) loaded in the retracted position. When the leg support is assembled to the cushion frame, the leg support may be at least one of (a) pre-stressed; (b) pre-loaded. The leg support may be configured to increase a seating surface area in movement from the retracted position to the extended position. The leg support may be configured to rotate about the cushion frame. The leg support may comprise a first shape when in the retracted position and a second shape when in the extended position. The first shape may comprise a first arc length and the second shape may comprise a second arc length greater than the first arc length. The first shape may comprise a curved shape; the second shape may comprise a straightened shape. The first shape may conform to a shape of the cushion frame. The first shape may comprise a wound shape and the second shape may comprise an unwound shape. The first shape may extend forward of the cushion frame; the second shape may be tucked under the cushion frame. The retracted position may comprise a lowered position and the extended position may comprise a raised position. The leg support may be configured to raise in movement from the retracted position to the extended position. The leg support may be configured to collapse in movement from the extended position to the retracted position. The leg support may be configured to provide a first thigh angle when in the retracted position and a second thigh angle when in the extended position. The second thigh angle may be greater than the first thigh angle. The leg support may be configured to provide a first cushion exit point when in the retracted position and a second cushion exit point when in the extended position. The leg support may be configured to wrap around the cushion frame. The leg support may comprise a cantilever relative to the cushion frame. The cushion frame may comprise a stop. The leg support may be configured to deflect against the stop. The leg support may be configured to wrap around the stop when in the retracted position. The leg support may be configured to flex when the seat is occupied. The leg support may be configured to apply a tensile force to the cushion frame when the leg support is in the extended position and the seat is occupied. The leg support may be configured to apply a compressive force to the cushion frame when the leg support is in the retracted position and the seat is occupied. The leg support may comprise a fulcrum; the fulcrum may be configured to shift as the leg support moves between the extended position and the retracted position. The leg support may comprise a compliant panel. The leg support may comprise a deformable panel. The leg support may comprise a TPE material. The leg support may comprise a spring comprising a first end coupled to a top side of the cushion frame and a second end coupled to a bottom side of cushion frame. The spring may be wound about the cushion frame when installed to the cushion frame. The spring may comprise a set of springs. The spring may comprise a spring steel material. The spring may be configured to wind and unwind. The seat may comprise a cable configured to at least one of (a) deform the spring; (b) pull the spring to move the leg support toward the retracted position. The cable may be coupled to the spring below the cushion frame between the first end of the spring and the second end of the spring. The seat may comprise a cable configured to provide a force to the spring (a) to pivot the first end relative to the cushion frame and (b) to pivot the second end relative to the cushion frame. The leg support may comprise a spring coupled to a panel. The panel may be molded on the spring. The seat may comprise a mechanism configured to adjust the leg support. The mechanism may comprise a cable mechanism. The mechanism may comprise an actuator. The actuator may be configured to pull a cable to move the leg support toward the extended position. The actuator may be configured to pull a cable to straighten the leg support. The actuator may comprise a screw drive. The actuator may comprise a motor. The seat may comprise a pad. The pad may comprise a foam. The pad may comprise a body and a flap. The flap may be configured to move relative to the body as the leg support moves between the retracted position and the extended position. The body may be fixed to the cushion frame; the flap may be configured to move above the body relative to the cushion frame as the leg support moves between the retracted position and the extended position. The seat may comprise a spring between the body and the flap. The seat may comprise at least one of (a) a panel between the body and the flap; (b) a suspension mat between the body and the flap. The seat may comprise a spring and a flexible panel between the body and the flap.

The present invention relates to a seat assembly; the seat assembly may comprise a base comprising a frame, a support comprising a spring element, a cushion and a pad. The cushion and pad may provide a deformable support surface. The support and/or spring element may be configured to move between retracted position and extended position. The support may be configured move between extended position and/or retracted position by movement of the spring element. The support may deflect to support an occupant. The support may be configured to increase seating surface area in movement from retracted position to extended position; the deformable support surface may be configured to provide a pressure distribution by variation of seating surface area. The pad may be supported by the spring element; the spring element may be wound to retract and unwound to extend. The cushion may provide a fulcrum for the support. The support may be configured to support a cushion assembly.

### FIGURES

FIG. 1A is a schematic perspective view of a vehicle according to an exemplary embodiment.

FIG. 1B is a schematic perspective cut-away view of a vehicle showing a vehicle interior according to an exemplary embodiment.

FIGS. 2A and 2B are schematic perspective views of a seat assembly for a vehicle occupant according to an exemplary embodiment.

FIG. 3 is a schematic partial perspective exploded view of a seat assembly for a vehicle occupant according to an exemplary embodiment.

FIG. 4 is a schematic partial perspective exploded view of a seat assembly for a vehicle occupant according to an exemplary embodiment.

FIGS. 5A through 5D are schematic partial perspective views of a seat assembly for a vehicle occupant according to an exemplary embodiment.

FIGS. 6A through 6D are schematic partial section views of a seat assembly for a vehicle occupant according to an exemplary embodiment.

FIGS. 7A and 7B are schematic partial section views of a seat assembly for a vehicle occupant according to an exemplary embodiment.

FIGS. 8A and 8B are schematic partial section views of a seat assembly for a vehicle occupant according to an exemplary embodiment.

FIGS. 9A through 9D are schematic perspective views of a spring element for a seat assembly for a vehicle occupant according to an exemplary embodiment.

FIG. 10 is a schematic perspective view of a spring element and a cable for a seat assembly for a vehicle occupant according to an exemplary embodiment.

FIGS. 11A and 11B are schematic partial perspective views of a spring element and brackets for a seat assembly for a vehicle occupant according to an exemplary embodiment.

FIG. 12A is a schematic exploded perspective view of a spring element and brackets for a seat assembly for a vehicle occupant according to an exemplary embodiment.

FIG. 12B is a schematic perspective view of a spring element and brackets for a seat assembly for a vehicle occupant according to an exemplary embodiment.

FIG. 13 is a schematic perspective view of a spring element and brackets for a seat assembly for a vehicle occupant according to an exemplary embodiment.

FIGS. 14A and 14B are schematic perspective views of a spring element and a frame for a seat assembly for a vehicle occupant according to an exemplary embodiment.

FIG. 15A is a schematic perspective bottom view of a spring element and a frame for a seat assembly for a vehicle occupant according to an exemplary embodiment.

FIG. 15B is a schematic perspective top view of a frame and a bracket for a seat assembly for a vehicle occupant according to an exemplary embodiment.

FIG. 15C is a schematic perspective bottom view of a frame for a seat assembly for a vehicle occupant according to an exemplary embodiment.

FIG. 15D is a schematic perspective top view of a frame for a seat assembly for a vehicle occupant according to an exemplary embodiment.

FIG. 16A is a schematic bottom perspective bottom view of a spring element, a cushion and a bracket for a seat assembly for a vehicle occupant according to an exemplary embodiment.

FIG. 16B is a schematic bottom perspective bottom view of a spring element and a bracket for a seat assembly for a vehicle occupant according to an exemplary embodiment.

FIG. 17A is a schematic perspective view of a cushion, a spring element, a pad and a mechanism for a seat assembly for a vehicle occupant according to an exemplary embodiment.

FIG. 17B is a schematic perspective view of a cushion, a spring element and a mechanism for a seat assembly for a vehicle occupant according to an exemplary embodiment.

FIG. 18A is a schematic section view of a cushion, a pad and a spring element for a seat assembly for a vehicle occupant according to an exemplary embodiment.

FIG. 18B is a schematic partial section view of a cushion, a pad and a spring element for a seat assembly for a vehicle occupant according to an exemplary embodiment.

FIG. 19A is a schematic perspective view of a spring element, a cable and a mechanism for a seat assembly for a vehicle occupant according to an exemplary embodiment.

FIG. 19B is a schematic perspective view of a spring element and a cable for a seat assembly for a vehicle occupant according to an exemplary embodiment.

FIG. 19C is a schematic section view of a spring element and a cable for a seat assembly for a vehicle occupant according to an exemplary embodiment.

FIG. 19D is a schematic perspective view of a spring element, a cable and a bracket for a seat assembly for a vehicle occupant according to an exemplary embodiment.

FIG. 20A is a schematic block diagram for a seat assembly for a vehicle occupant according to an exemplary embodiment.

FIG. 20B is a schematic perspective view of a mechanism for a seat assembly for a vehicle occupant according to an exemplary embodiment.

FIG. 20C is a schematic perspective view of a mechanism for a seat assembly for a vehicle occupant according to an exemplary embodiment.

### DESCRIPTION

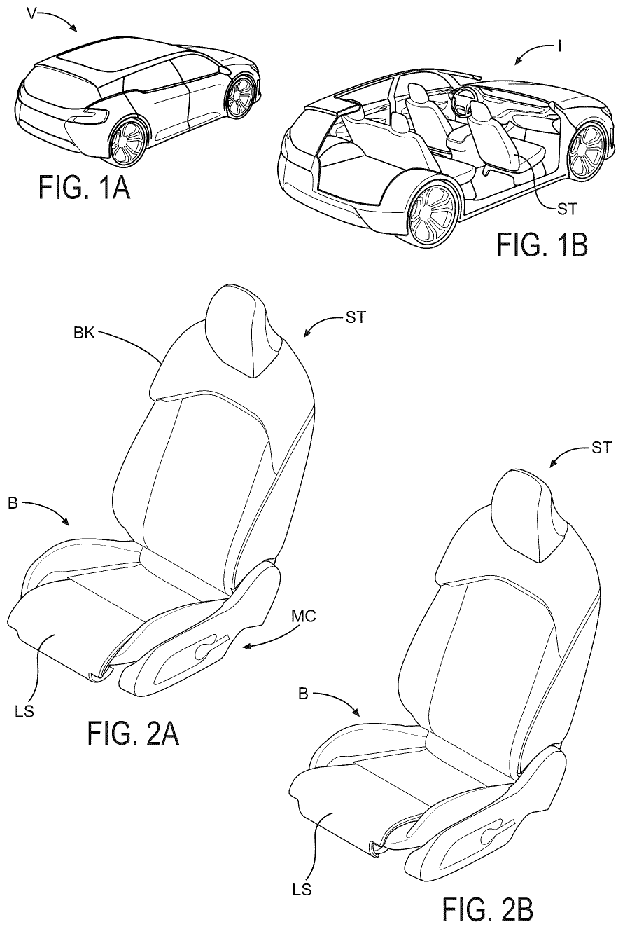

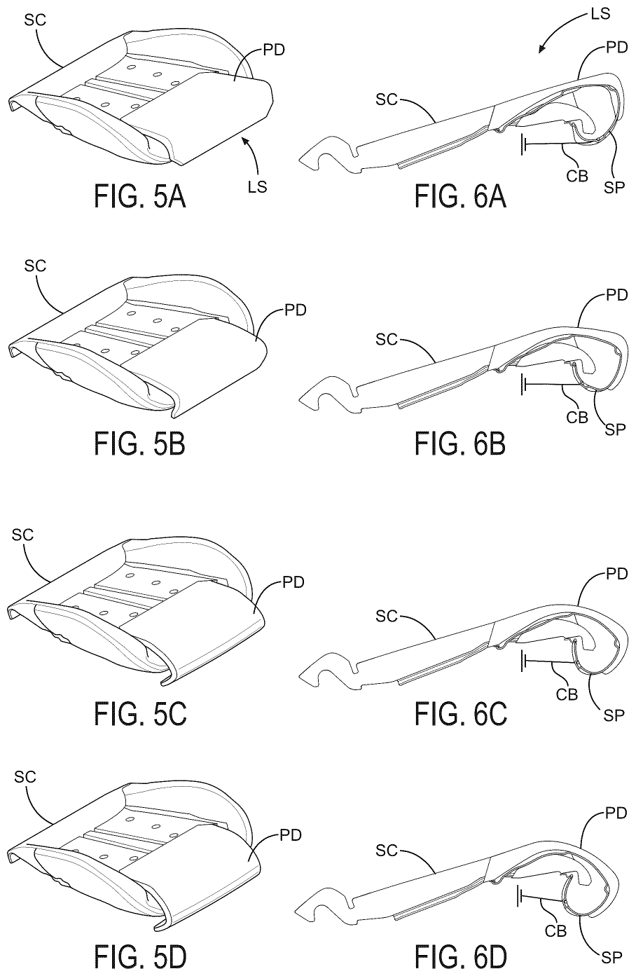

Referring to FIGS. 1A-1B and 2A-2B, a vehicle V is shown with an interior I comprising a seat assembly ST configured to provide a seat for an occupant of a vehicle; seat assembly ST may comprise with a base B shown as seat base/structure (e.g. providing the seat) and a structure shown as back BK (e.g. providing back support); seat assembly ST may comprise a support for the seat of seat assembly ST shown as support LS; support LS may comprise a leg support movable relative to the base B; seat assembly may comprise a control element shown as operator control MC configured to facilitate selective movement/positioning of the seat/features (e.g. base, back, support, etc.) by an occupant of the vehicle; operator control MC may be configured to provide for adjustment/movement and positioning of support LS relative to the base B. See also FIGS. 5A-5D and 6A-6D.

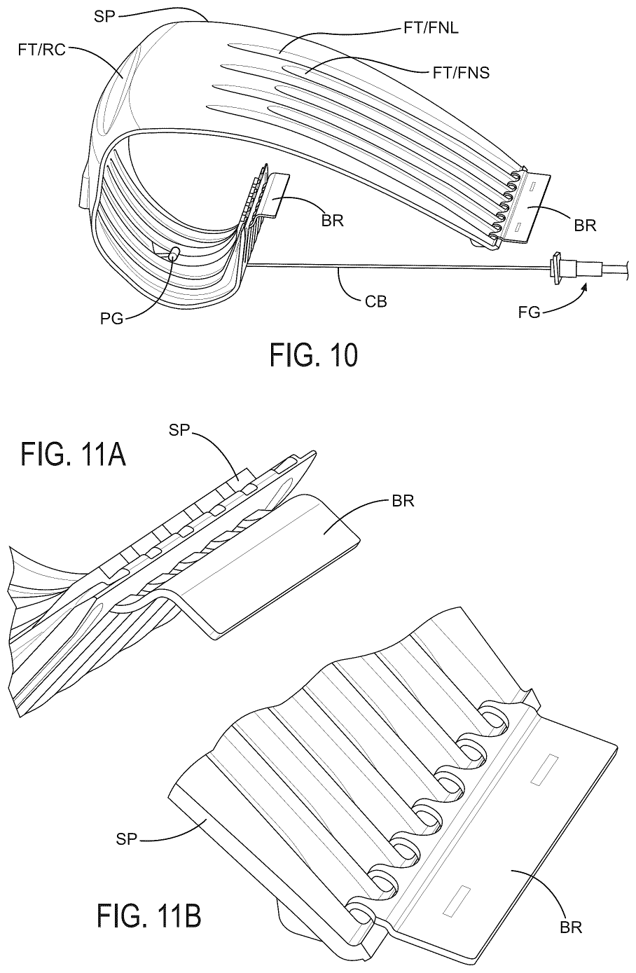

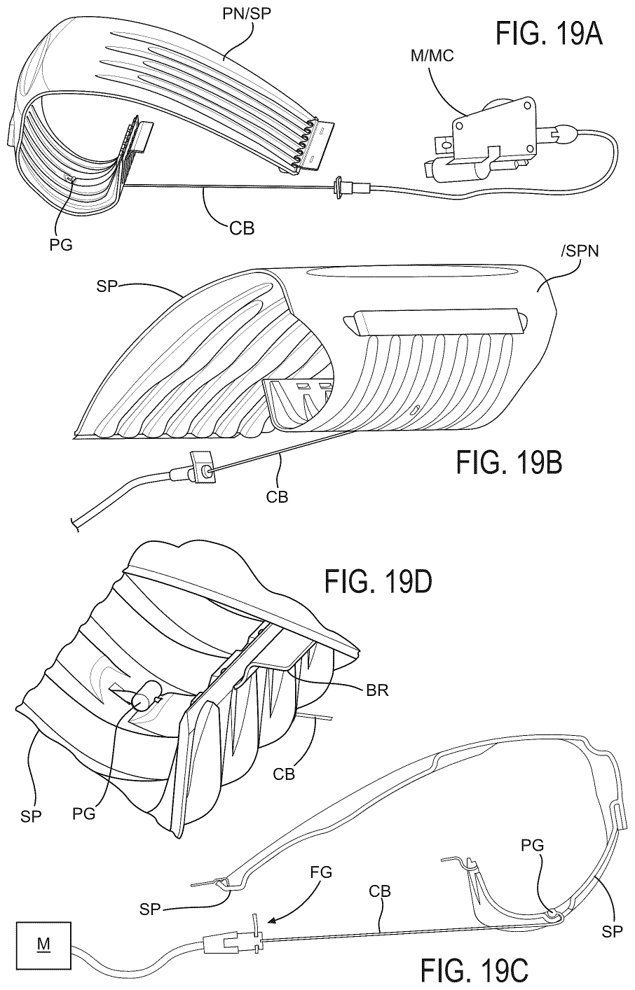

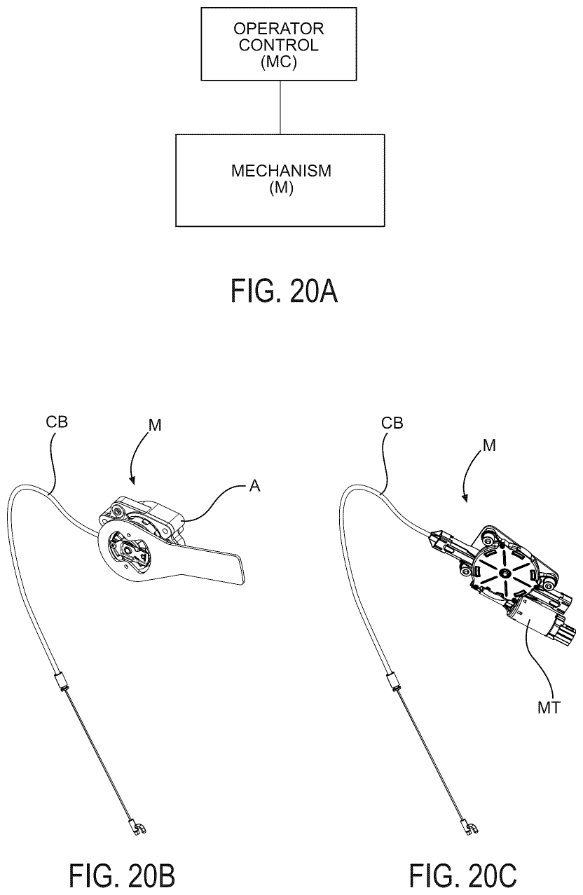

According to an exemplary embodiment as shown schematically in FIGS. 2A-2B, 3 and 4, seat assembly ST may comprise a structure shown as frame FR (e.g. a rigid/metal pan structure, etc.) at the base B and a body BD provided by a structure shown as a cushion SC (e.g. a foam pad, etc.); base B may comprise a chassis movable such as on a track system; movable support LS of seat assembly ST may comprise a composite structure comprising a spring element SP configured to be coupled to the frame FR (such as by connectors shown as brackets BR); seat ST may comprise a structure shown as pad PD (e.g. a foam pad) supported by the movable support LS; seat assembly ST may comprise an adjuster shown as mechanism M comprising an actuator and/or motor with the operator control MC. See also FIGS. 2A-2B, 10, 19A-19D and 20A-20C.

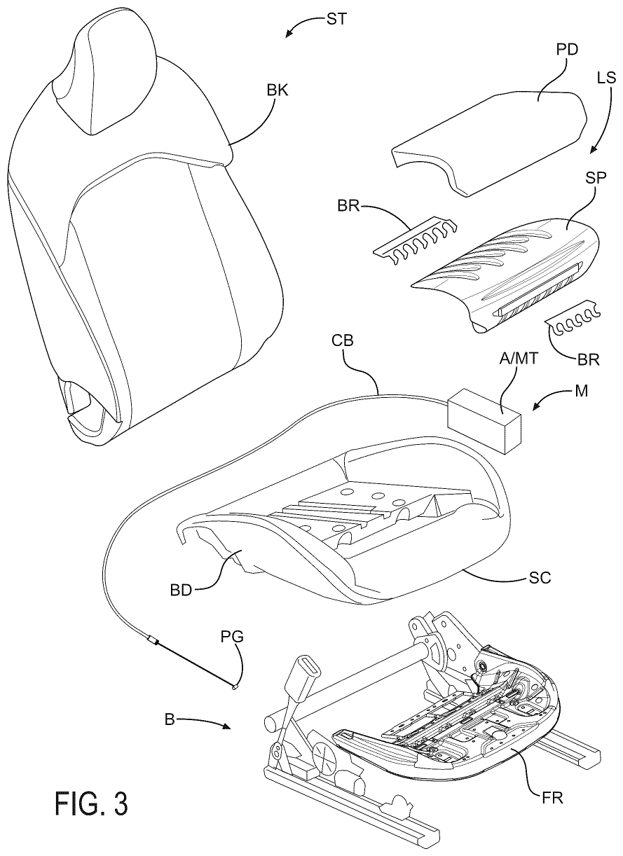

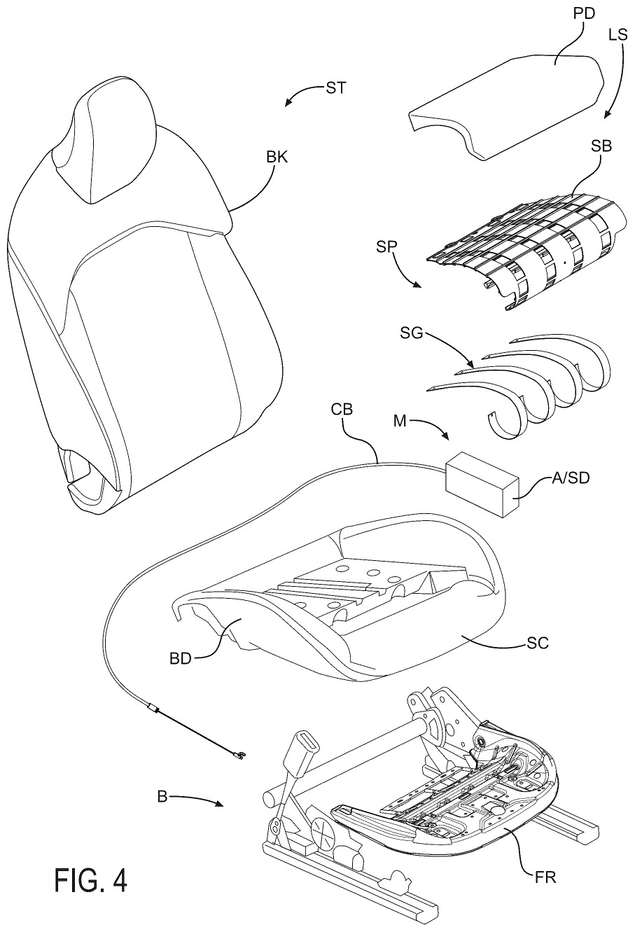

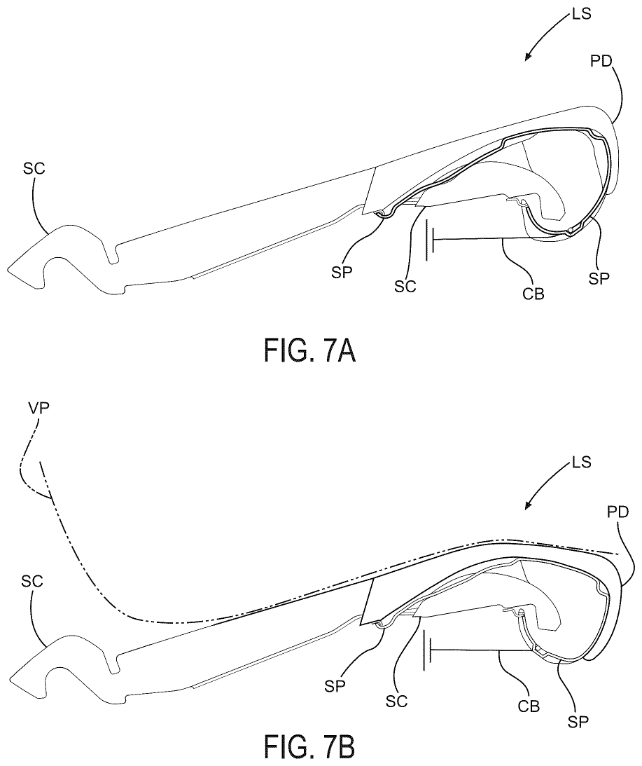

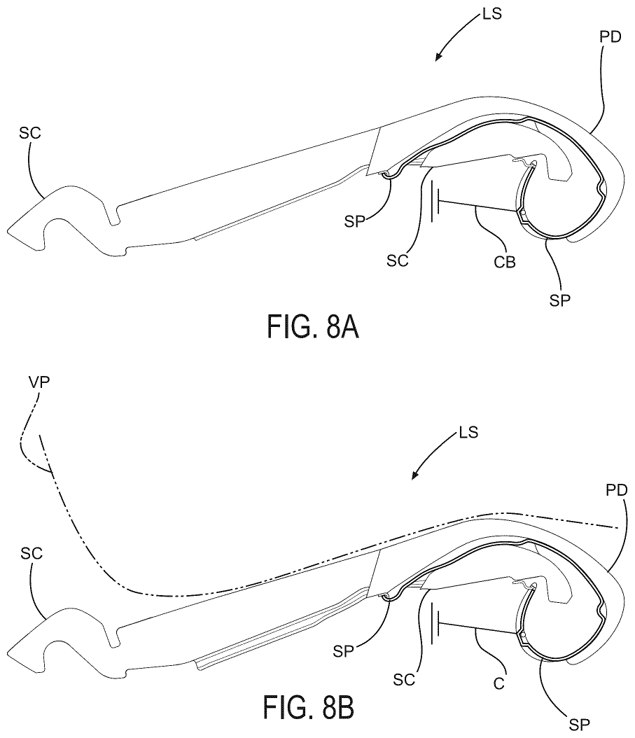

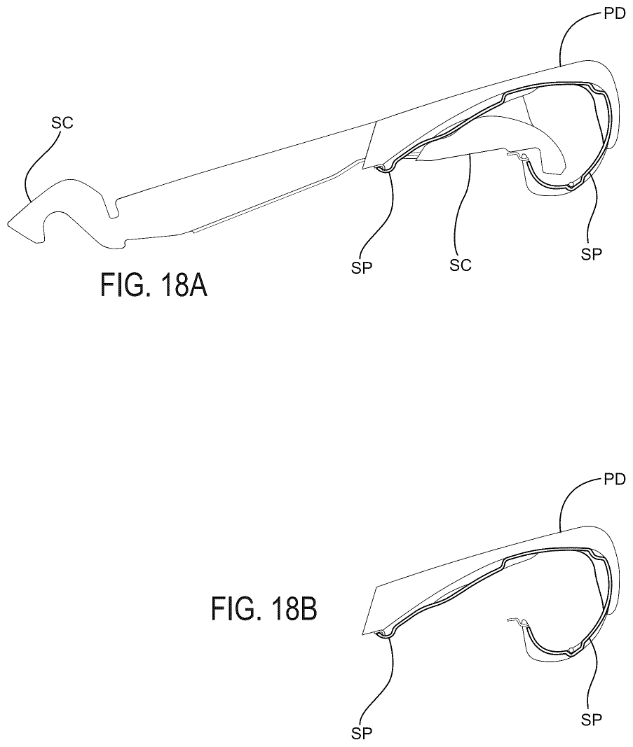

According to an exemplary embodiment as shown schematically in FIGS. 2A-2B, 3, 4, 5A-5D and 6A-6D, seat assembly ST may comprise a support LS with spring element SP integrated with a cushion assembly comprising cushion SC and pad PD to provide a seating surface at the base B. As indicated schematically in FIG. 3, the support LS may comprise a spring element SP comprising a flexible panel such as a spring structure. As indicated schematically in FIG. 4, the support LS may comprise a spring element SP comprising a substrate SB and springs shown as spring members SG (e.g. spring plates, spring strips, etc.). As indicated schematically in FIGS. 2A-2B, 3, 4, 5A-5D, 6A-6B, 7A-7B and 8A-8B, the spring element SP for support LS may be configured to provide a flexible structure configured to provide support a seating surface for an occupant of the vehicle (e.g. indicated schematically as seated occupant VP in FIGS. 7B and 8B). See also FIGS. 18A-18B.

As indicated schematically in FIGS. 2A-2B, 5A-5D, 6A-6D, 7A-7B and 8A-8B, the spring element SP for support LS may be configured to provide a flexible structure with the cushion assembly at base B configured to be adjusted such as may be intended to provide enhanced comfort/support for the seating surface for the occupant of the vehicle (e.g. adjusted for size, height, mass, form, reach, preference, position, etc.); support LS with spring element SP may be configured to be moved between an extended position (see FIGS. 5A and 6A and 7A-7B) toward a retracted position (see FIGS. 5D and 6D and 8A-8B); as indicated schematically in FIGS. 7A-7B and 8A-8B, adjustment of the support LS and presence of the vehicle occupant VP in the seat may deform the flexible structure and support surface provided by the support LS and cushion assembly (e.g. cushion SC and pad PD); as indicated schematically, spring element SP and cushion SC may be configured to provide a shape/form and support/structure for the seating surface. As indicated schematically in FIGS. 5A-5D, 6A-6D, 7A-7B and 8A-8B, support LS with spring element SP may be configured to be adjusted in shape/form to provide a support/structure for the seating surface from the extended position with pad PD and support LS extended (see FIGS. 5A and 6A and 7A-7B) through a range of intermediate positions toward the retracted position with pad PD and support LS retracted (see FIGS. 5D and 6D and 8A-8B); adjustment may be provided by adjuster/mechanism M at operator control MC (e.g. motor MT, screw drive, etc.). See also FIGS. 2A-2B, 10, 19A-19D and 20A-20C.

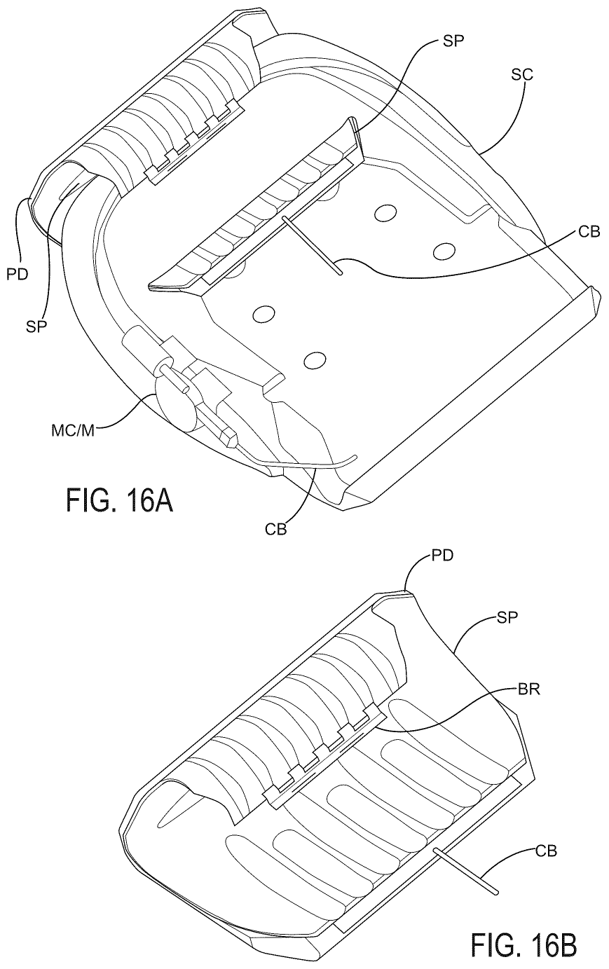

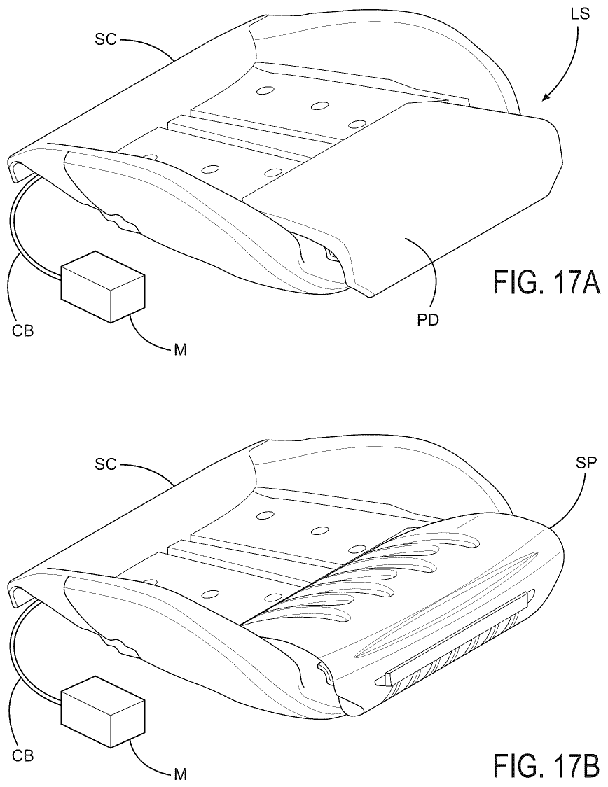

As indicated schematically in FIGS. 5A-5D, 6A-6D, 7A-7B and 8A-8B, the cushion SC or the cushion assembly with support LS with spring element SP may be configured to provide support to provide the shape/form for the seating surface in movement from the extended position with pad PD and support LS extended (see FIGS. 5A and 6A and 7A-7B) through the range of intermediate positions toward the retracted position with pad PD and support LS retracted; as indicated schematically, the support LS with spring element SP may be integrated with the cushion assembly comprising cushion SC and pad PD; spring element SP may fit into a recess/slot in cushion SC; pad PD may cover and/or be wrapped around spring element SP; a section of cushion SC may provide a shape retainer and/or fulcrum/support at or under spring element SP; the cushion assembly may be fit onto/around frame FR to facilitate the shape/form support/movement of the spring element SP of support LS in the range of movement (e.g. as moved such as by rolling/winding-unwinding between the extended position and the retracted position). See also FIGS. 16A-16B, 17A-17B and 18A-18B. As indicated schematically, the shape/form of the seating surface may be adjusted by adjustment of the shape/form of the support LS with spring element SP.

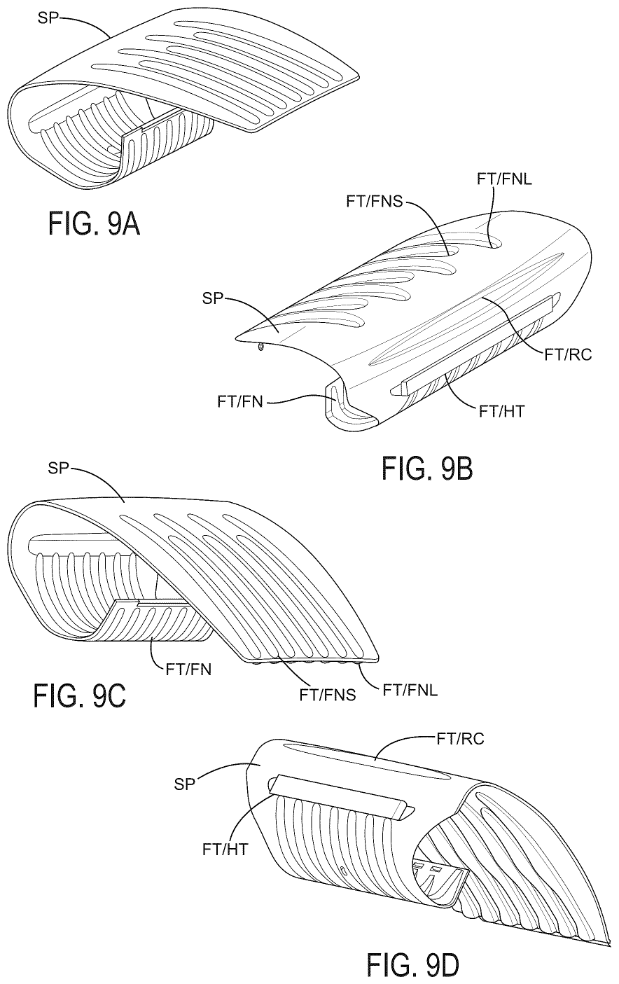

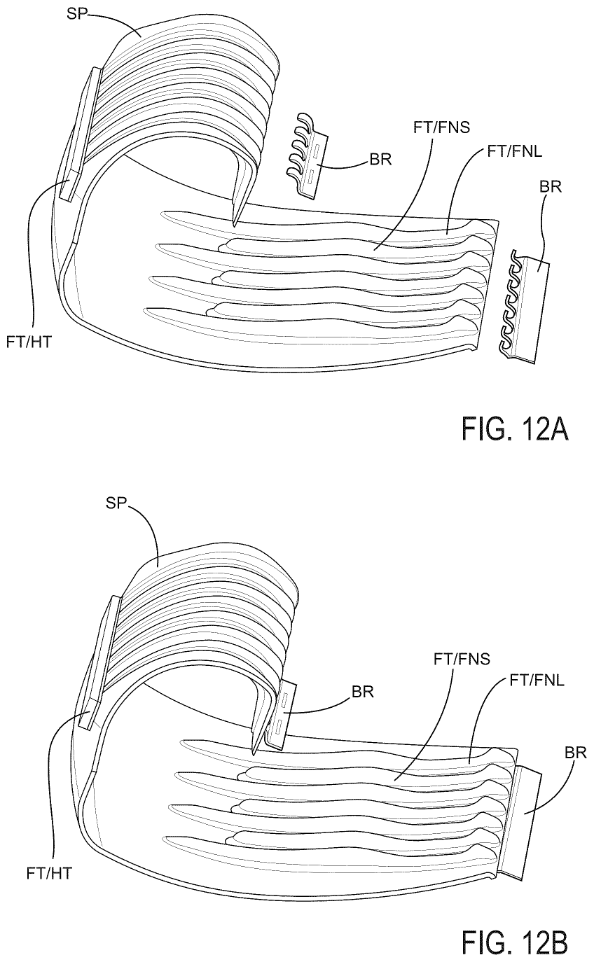

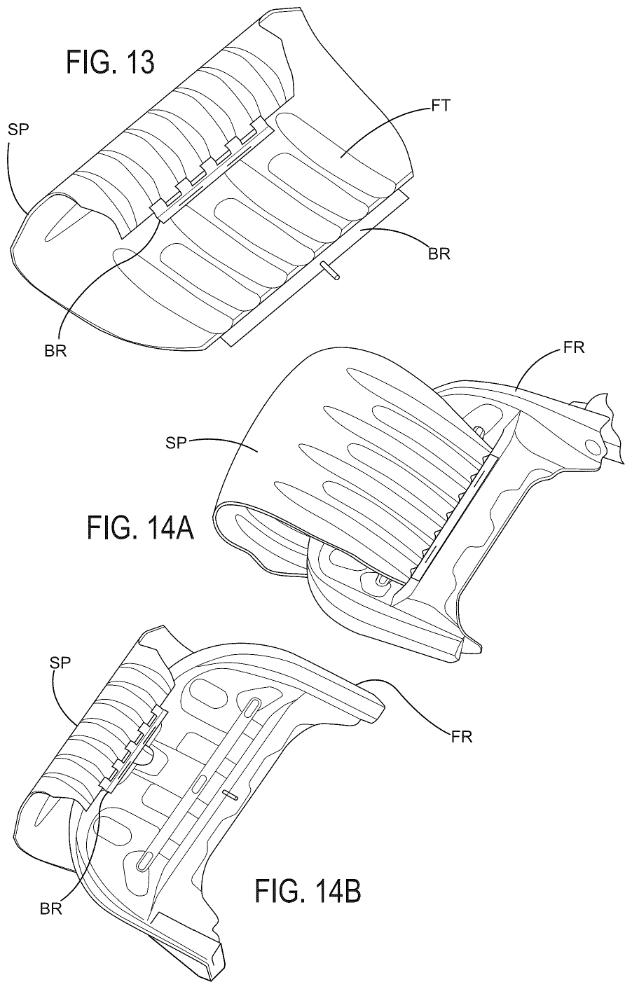

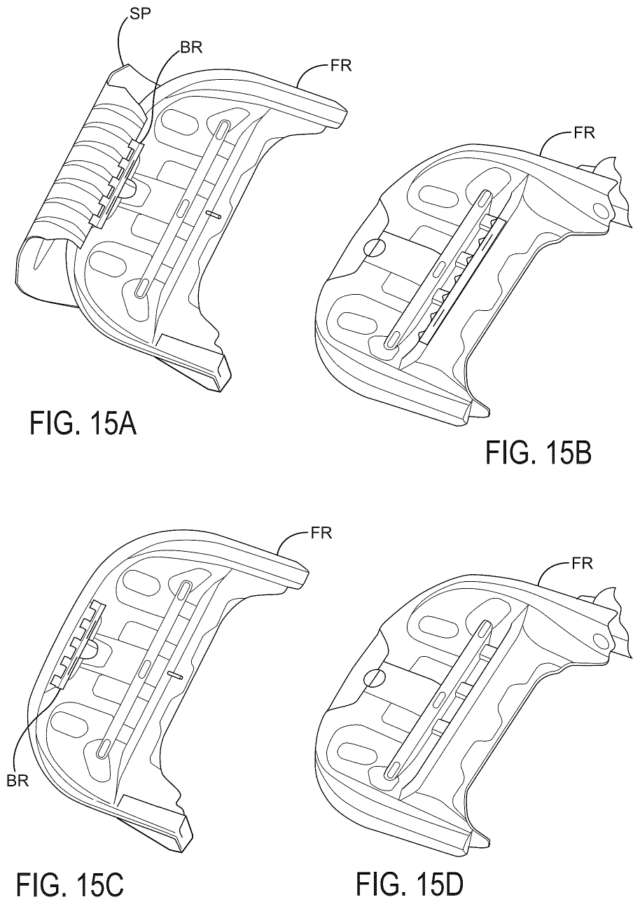

As indicated schematically in FIGS. 5A-5D, 6A-6D, 7A-7B and 8A-8B, the flexible member comprising the spring element SP of the support LS may be configured to provide the shape/form integrated with the cushion assembly for the seating surface in winding/unwinding movement from the extended/unwound position with pad PD and support LS extended (see FIGS. 5A and 6A and 7A-7B) through the range of intermediate positions toward the retracted/wound position with pad PD and support LS retracted. As indicated schematically, in FIGS. 2A-2B, 3, 4, 9A-9D and 10, the spring element SP of support LS may be installed/attached to the frame by connectors shown as brackets BR (e.g. providing a mounting point such as a flange, hinge, etc. at a base end and front end); the spring element SP of support LS may comprise design element such as features FT configured to modify the flexibility/rigidity and spring force; the spring element SP may operate as a sheet spring and/or may comprise spring members designed and/or selected to provide the spring force across a range intended to facilitate support from the extended position to the retracted position; features may comprise a recess shown as FT/RC and/or an attachment/clip FT/HT for a cover; features may comprise members/elements show as FN configured to modify the stiffness/spring force of the spring element SP; features FN may comprise a varying length such as short element FNS and long element FNL. See also FIGS. 11A-11B, 12A-12B, 13, 14A-14B, 15A-15D, 16A-16D, 17A-17B and 18A-18B. As indicated schematically in FIGS. 3, 4, 5A-5B, 6A-6B, 10, 11A-11B, 12A-12B, 13, 14A-14B and 15A-15D, support LS with spring element SP may be configured to operate as a beam member attached by bracket BR at a base end to the frame FR (e.g. fixed at a mounting flange) and at front end to the frame (e.g. providing a hinge/clip for pivotal movement). As indicated schematically in FIGS. 3, 4, 5A-5B, 6A-6B, 7A-7B, 8A-8B, 16A-16D, 17A-17B and 18A-18B, support LS with spring element SP may be integrated with the cushion assembly comprising cushion SC and pad PD to provide a support surface comprising a compound support surface to distribute force in a manner intended to enhance comfort for seating of a variety of vehicle occupants (e.g. with variations in size, form, preferences, etc.).

As indicated schematically in FIGS. 2A-2B, 3, 4, 5A-5D, 6A-6D, 7A-7B, 8A-8B, 10, 18A-18B, 19A-19D and 20A-20C, the flexible member comprising the spring element SP of the support LS may be configured to provide the shape/form integrated with the cushion assembly for the seating surface in winding/unwinding movement by selective adjustment by an operator control MT with a mechanism M from the extended/unwound position with pad PD and support LS extended (see FIGS. 5A and 6A and 7A-7B) through the range of intermediate positions toward the retracted/wound position with pad PD and support LS retracted; adjustment by the mechanism M may alter the shape/form and position of the support LS and the cushion assembly across the range of movement (e.g. indicated as by rolling/winding-unwinding of spring element SP between the extended position and the retracted position); spring element SP of support LS may be mounted/coupled to frame FR at a base end and front end; spring element SP of support LS may be coupled to the cable CB of mechanism M by a coupling shown as comprising a tip/end providing a plug PG; the cable CB of mechanism M may be secured to the frame FR and retained in a fitting FG and coupled to the spring element SP at the coupling shown as comprising a plug PG (e.g. barrel plug, etc.); movement of the cable CB through the mechanism (e.g. cable mechanism operated by motor, actuator, screw drive, manual operation, etc.) may move the spring element SP secured within the frame FR and integrated with the cushion assembly; retraction of the cable CB and plug PG may against spring force pull the spring element SP for support LS toward the retracted position supported by the cushion assembly (e.g. at a fulcrum, support shape, etc.); extension of the cable CB and plug PG may by spring force extend the spring element SP for support LS toward the extended position supported by the cushion assembly (e.g. at a fulcrum, support shape, etc.). As indicated schematically in FIGS. 3, 4 and 20A-20C, the mechanism may comprise a manually-operated actuator A (e.g. such as a screw drive) and/or a motor MT (e.g. such as an electric motor) operated by an operator control MT (e.g. such as a button) to provide for adjustment of the support LS for the seat surface. See also FIGS. 2A-2B, 5A-5D and 6A-6D.

As indicated schematically in FIGS. 2A-2B, 3, 4, 5A-5D, 6A-6D, 7A-7B, 8A-8B, 19A-19D, the support LS may comprise a spring/spring element SG shown as comprising a flexible panel shown as a curved shape/form spring panel PN.

According to any exemplary embodiment as indicated in FIGS. 2A-2B, 3, 4, 5A-5D, 6A-6D, 7A-7B, 8A-8B, 10, 19A-19D and 20A-20C, the seat assembly ST may be configured to selectively provide for shape/form of the seating surface as adjusted at the mechanism M with control MC for the preference/comfort of the vehicle occupant VP by adjustment of the shape/form of the support LS with spring element SP integrated with the cushion assembly in the frame FR of the seat base B.

According to an exemplary embodiment as shown schematically in FIGS. 2A-2B, 3, 4, 5A-5D, 6A-6D, 7A-7B, 8A-8B, 10, 17A-17B, 18A-18B, 19A-19D and 20A-20C, the seat assembly for an occupant of a vehicle may comprise a base and a support coupled to a frame with a cushion and a pad movable relative to the base; the seat assembly may comprise a support comprising a spring element movable to extend and retract; the seat assembly may comprise a base and a support comprising a spring element coupled to a frame with a cushion and a pad and movable relative to the base; the seat assembly may comprise a support comprising a spring element configured to provide a deformable support surface for an occupant; the seat assembly may a support comprising a spring element integrated with a cushion assembly configured to provide a deformable support surface for an occupant; the seat assembly may comprise a moveable spring element integrated with a cushion assembly configured to provide a deformable support surface to facilitate enhance comfort for an occupant.

According to an exemplary embodiment as shown schematically in FIGS. 2A-2B, 3, 4, 5A-5D, 6A-6D, 7A-7B, 8A-8B, 10, 17A-17B, 18A-18B, 19A-19D and 20A-20C, the seat assembly for an occupant of a vehicle may comprise a base comprising a frame; a seat back coupled to the base; a support coupled to the frame comprising a spring element; a cushion supported by the frame; and a pad coupled to the support and movable relative to the base; the support may be configured for movement of the pad between an extended position and a retracted position.

According to an exemplary embodiment as shown schematically in FIGS. 2A-2B, 3, 4, 5A-5D, 6A-6D, 7A-7B, 8A-8B, 10, 17A-17B, 18A-18B, 19A-19D and 20A-20C, the seat assembly for an occupant of a vehicle may comprise a base comprising a frame; a seat back coupled to the base; a support coupled to the frame comprising a spring element; a cushion; and a pad coupled to the support and movable relative to the base; the support may be configured for movement between an extended position and a retracted position; the cushion and the pad may be configured to provide a deformable support surface for the occupant.

According to an exemplary embodiment as shown schematically in FIGS. 2A-2B, 3, 4, 5A-5D, 6A-6D, 7A-7B, 8A-8B, 10, 17A-17B, 18A-18B, 19A-19D and 20A-20C, the seat assembly for an occupant of a vehicle may comprise a base comprising a frame; a support coupled to the frame comprising a spring element; a cushion; and a pad coupled to the support and movable relative to the base; the support may be configured for movement between an extended position and a retracted position; the support and the cushion and the pad may be configured to provide a deformable support surface for the occupant.

### Exemplary Embodiments—A

According to an exemplary embodiment as shown schematically in FIGS. 2A-2B, 3, 4, 5A-5D, 6A-6D, 7A-7B, 8A-8B, 10, 17A-17B, 18A-18B, 19A-19D and 20A-20C, a seat assembly ST for an occupant of a vehicle may comprise a base B comprising a frame FR; a support LS coupled to the frame FR comprising a spring element SP; a cushion SC; and a pad PD on the support LS and movable relative to the base B; the support LS may be configured for movement between an extended position and a retracted position; the cushion SC and the pad PD may be configured to provide a deformable support surface for the occupant.

According to an exemplary embodiment as shown schematically in FIGS. 2A-2B, 3, 4, 5A-5D, 6A-6D, 7A-7B, 8A-8B, 10, 17A-17B, 18A-18B, 19A-19D and 20A-20C, the pad PD may be coupled to the support LS. The extended position may comprise a default position for the support LS. The support LS with the cushion SC and the pad PD may be configured to provide a deformable support surface for the occupant. The cushion SC may be coupled to the frame FR; the cushion SC may be configured to provide a fulcrum for the support LS; the cushion SC may be configured to provide a support structure for the spring element SP of the support LS. The pad PD may be configured to be supported by the spring element SP of the support LS; the pad PD may be configured to be extended from the base B when the support LS is in the extended position; the pad PD may be configured to be retracted toward the base B when the support LS is in the retracted position. Sec FIGS. 2A-2B, 3, 4, 5A-5D, 6A-6D, 7A-7B, 8A-8B and 18A-18B.

According to an exemplary embodiment as shown schematically in FIGS. 2A-2B, 3, 4, 5A-5D, 6A-6D, 7A-7B, 8A-8B, 10, 17A-17B, 18A-18B, 19A-19D and 20A-20C, the spring element SP may be configured to be wound to move the support LS toward the retracted position; the spring element SP may be configured to be unwound to move the support LS toward the extended position; the support LS may be configured to deflect to support the occupant; the spring element SP may be configured to deflect.

According to an exemplary embodiment as shown schematically in FIGS. 2A-2B, 3, 4, 5A-5D, 6A-6D, 7A-7B, 8A-8B, 10, 17A-17B, 18A-18B, 19A-19D and 20A-20C, the deformable support surface may comprise a reactive surface configured to support the occupant; the support LS may be configured to provide the reactive surface configured to support the occupant; the support LS may be configured to provide a reactive surface configured to provide a reactive force to support the occupant; the support LS may be configured to communicate a reactive force through the pad PD and/or the cushion SC configured to support the occupant; the support LS may be configured provide a reactive surface configured to deflect to provide a reactive force to support the occupant; the support LS may be configured provide a reactive surface configured to deflect to provide a reactive force with varying contact pressure to support the occupant; the reactive surface may be provided by the spring element SP and the cushion SC and the pad PD; the support LS may be configured provide a reactive surface configured to deflect to provide a reactive force to support the occupant; the cushion SC may be configured to provide shape control for the reactive surface. See FIGS. 2A-2B, 3, 4, 5A-5D, 6A-6D, 7A-7B, 8A-8B and 18A-18B.

According to an exemplary embodiment as shown schematically in FIGS. 2A-2B, 3, 4, 5A-5D, 6A-6D, 7A-7B, 8A-8B, 10, 17A-17B, 18A-18B, 19A-19D and 20A-20C, the deformable support surface may comprise a compound support surface configured to support the occupant; the compound support surface may comprise the support LS with the cushion SC and the pad PD to provide a variable pressure distribution by variation of the shape of the support LS; the compound support surface may comprise the support LS with the cushion SC and the pad PD to provide a variable pressure distribution by variation of the shape of the support LS with an adjuster comprising an operator control MC and a mechanism M; the compound support surface may comprise the support LS with the cushion SC and the pad PD to provide a selectable pressure distribution by selective variation of the shape of the support LS with an adjuster comprising an operator control MC and a mechanism M. The reactive surface may comprise an extended shape and a retracted shape; the reactive surface may be in the extended shape when the pad PD is in an extended position; the reactive surface may be in the retracted shape when the pad PD is in a retracted position; the reactive surface may be moved toward the retracted shape when the support LS is moved toward the retracted position by movement of the spring element SP; the reactive surface may be rolled toward the extended shape when the support LS is moved toward the extended position by unwinding of the spring element SP. See FIGS. 2A-2B, 3, 4, 5A-5D, 6A-6D, 7A-7B, 8A-8B and 18A-18B.

According to an exemplary embodiment as shown schematically in FIGS. 2A-2B, 3, 4, 5A-5D, 6A-6D, 7A-7B, 8A-8B, 10, 17A-17B, 18A-18B, 19A-19D and 20A-20C, the spring element SP may comprise a flexible panel. The spring element may comprise at least one of (a) a curved sheet spring; (b) a curved sheet; (c) a formed curved sheet. The spring element may comprise at least one of (a) a curved form; (b) a curved shape. The spring element may comprise a pre-form shape. The spring element may comprise a spring member. The spring element may comprise a spring strip. The spring element may comprise a segmented spring element.

According to an exemplary embodiment as shown schematically in FIGS. 2A-2B, 3, 4, 5A-5D, 6A-6D, 7A-7B, 8A-8B, 10, 17A-17B, 18A-18B, 19A-19D and 20A-20C, the support LS may comprise a feature FT. The spring element SP may comprise a feature FT. The feature may comprise at least one of (a) a stiffener; (b) a set of features; (c) a set of stiffeners; (d) a set of recesses; (e) a set of transverse recesses; (f) a set of transverse recesses of varying length; (g) a set of ribs; (h) a set of ribs of varying length. The feature may comprise a set of transverse ribs of varying length. The feature FT may be configured to provide a stiffness of the spring element. The feature may comprise a set of features configured to provide a spring force for the spring element. The feature FT may comprise at least one of (a) a recess; (b) a recess at a front end; (c) a recess configured to facilitate deflection of the spring element. The feature FT may comprise a set of stiffeners and a recess. The feature FT may comprise an attachment for a cover material.

According to an exemplary embodiment as shown schematically in FIGS. 2A-2B, 3, 4, 5A-5D, 6A-6D, 7A-7B, 8A-8B, 10, 17A-17B, 18A-18B, 19A-19D and 20A-20C, the spring element may comprise a wedge shape. The spring element may comprise at least one of (a) a resin material; (b) a metal element; (c) a TPE material. The spring element may comprise a substrate and a set of spring strips. The support LS may be configured to be moved toward the retracted position by winding the spring element; the support LS may be configured to be moved toward the extended position by movement of the spring element. See FIGS. 2A-2B, 3, 4, 5A-5D, 6A-6D, 7A-7B, 8A-8B and 18A-18B.

According to an exemplary embodiment as shown schematically in FIGS. 2A-2B, 3, 4, 5A-5D, 6A-6D, 7A-7B, 8A-8B, 10, 17A-17B, 18A-18B, 19A-19D and 20A-20C, the seat assembly ST may comprise a cushion assembly comprising the cushion SC and the pad PD; the cushion SC and pad PD may be configured to provide an interface within the cushion assembly; the pad PD may be configured to fit with the cushion SC at the interface; the support LS may be configured to support the cushion assembly; the spring element SP may be within the cushion assembly. The frame FR may comprise a cushion frame configured to support the cushion assembly. The cushion SC may comprise a slot; the spring element SP may be in the slot. The spring element SP may be in the slot adjacent a connector to the frame FR. The cushion assembly may comprise a slot; the spring element SP may be in the slot.

According to an exemplary embodiment as shown schematically in FIGS. 2A-2B, 3, 4, 5A-5D, 6A-6D, 7A-7B, 8A-8B, 10, 17A-17B, 18A-18B, 19A-19D and 20A-20C, the support LS may be coupled to the frame FR. The support LS may comprise the spring element SP and a set of mounting brackets BR; the support LS may be connected to the frame FR at the set of mounting brackets BR. The support LS may comprise a base end and a front end. The spring element SP of the support LS may be configured to be supported at a base end and a front end. The spring element SP may be coupled to the frame FR; the spring element SP may be coupled to the frame FR at a connector; the connector may comprise a bracket BR. The spring element SP may be coupled to the frame FR by at least one of (a) a bracket; (b) a mounting flange; (c) a clip; (d) a hook. The spring element SP may comprise a base end and front end; the base end of the spring element SP may be coupled to the frame FR; the front end of the spring element SP may be coupled to the frame FR. The front end of the spring element SP may be coupled to the frame FR by a clip. The front end of the spring element SP may be pivotally coupled to the frame FR at a hinge; the base end of the spring element SP may be coupled to the frame FR by a bracket BR. The support LS may comprise a beam support supported at a base end and a front end. Scc FIGS. 2A-2B, 3, 4, 5A-5D, 6A-6D, 7A-7B, 8A-8B and 18A-18B.

According to an exemplary embodiment as shown schematically in FIGS. 2A-2B, 3, 4, 5A-5D, 6A-6D, 7A-7B, 8A-8B, 10, 17A-17B, 18A-18B, 19A-19D and 20A-20C, the support LS may comprise a fulcrum; the support LS may comprise a fulcrum within the cushion SC. The support LS may comprise at least one of (a) a fulcrum between a base end and a front end; (b) a fulcrum for the spring element SP between the base end and the front end; (c) a fulcrum comprising a support point for the spring element SP. The cushion SC and the pad PD may be configured to provide an interface; the interface may be provided adjacent to a fulcrum for the spring element SP; the cushion SC may be configured to compress adjacent to the fulcrum. The cushion SC may be configured to provide a stop for the support LS. The cushion SC may be configured to provide a shape control for the support LS. The cushion may be configured to provide a shape control under the spring element SP of the support LS. The pad PD may be configured to deflect adjacent to the fulcrum. The pad PD may be at least partially wrapped onto the spring element SP. The cushion may comprise a foam pad; the pad PD may comprise a foam pad. The support LS may comprise at least one of (a) a cushion extender; (b) a leg support.

According to an exemplary embodiment as shown schematically in FIGS. 2A-2B, 3, 4, 5A-5D, 6A-6D, 7A-7B, 8A-8B, 10, 17A-17B, 18A-18B, 19A-19D and 20A-20C, the spring element SP may be provided in a curved shape. The spring element SP may be provided in a default shape; the default shape may comprise a partially unwound shape; the spring element SP may be configured to be pulled from the partially unwound shape toward a partially wound shape. A shape of the spring element SP may be a curved shape. The seat assembly ST may comprise a mechanism M configured to alter the curved shape of the spring element SP between a partially unwound shape and a partially wound shape. The seat assembly ST may comprise a mechanism M configured to move the support LS toward the retracted position. The seat assembly ST may comprise a mechanism M configured to wind the spring element SP toward the retracted position and to unwind the spring element SP toward the extended position. The seat assembly ST may comprise a mechanism M configured to move the support LS between a retracted position and an extended position by altering the shape of the spring element SP. The seat assembly ST may comprise a mechanism M configured to move the support LS between the retracted position and the extended position. The mechanism M may comprise at least one of (a) a cable drive mechanism; (b) an actuator; (c) a motor; (d) a drive mechanism. The mechanism M may comprise a cable CB with a plug PG coupled to the support LS; the cable CB may be configured to move the support LS toward the retracted position. The spring element SP may be provided in an extended position; the mechanism M may be configured to wind the spring element SP toward the retracted position; the mechanism M may be configured to unwind the spring element SP toward the extended position. See FIGS. 2A-2B, 3, 4, 5A-5D, 6A-6D, 7A-7B, 8A-8B, 18A-18B, 19A-19D and 20A-20C.

According to an exemplary embodiment as shown schematically in FIGS. 2A-2B, 3, 4, 5A-5D, 6A-6D, 7A-7B, 8A-8B, 10, 17A-17B, 18A-18B, 19A-19D and 20A-20C, the seat assembly ST for an occupant of a vehicle may comprise a base B comprising a frame FR; a support LS coupled to the frame FR comprising a spring element SP; a cushion SC supported by the frame FR; and a pad PD coupled to the support LS and movable relative to the base B. The support LS may be configured for movement of the pad PD between an extended position and a retracted position.

According to an exemplary embodiment as shown schematically in FIGS. 2A-2B, 3, 4, 5A-5D, 6A-6D, 7A-7B, 8A-8B, 10, 17A-17B, 18A-18B, 19A-19D and 20A-20C, the seat assembly ST for an occupant of a vehicle may comprise a base B comprising a frame FR; a seat back BK coupled to the base B; a support LS coupled to the frame FR comprising a spring element SP; a cushion SC supported by the frame FR; and a pad PD coupled to the support LS and movable relative to the base B; the support LS may be configured for movement of the pad PD between an extended position and a retracted position. Sec FIGS. 2A-2B, 3, 4, 5A-5D, 6A-6D, 7A-7B, 8A-8B and 18A-18B.

According to an exemplary embodiment as shown schematically in FIGS. 2A-2B, 3, 4, 5A-5D, 6A-6D, 7A-7B, 8A-8B, 10, 17A-17B, 18A-18B, 19A-19D and 20A-20C, the seat assembly ST for an occupant of a vehicle may comprise a base B comprising a frame FR; a seat back BK coupled to the base B; a support LS coupled to the frame FR comprising a spring element SP; a cushion SC; and a pad PD coupled to the support LS and movable relative to the base B; the support LS may be configured for movement between an extended position and a retracted position; the cushion SC and the pad PD may be configured to provide a deformable support surface for the occupant.

According to an exemplary embodiment as shown schematically in FIGS. 2A-2B, 3, 4, 5A-5D, 6A-6D, 7A-7B, 8A-8B, 10, 17A-17B, 18A-18B, 19A-19D and 20A-20C, the seat assembly ST configured to provide a seat for an occupant of a vehicle may comprise a base B comprising a frame FR; a support LS coupled to the frame FR comprising a spring element SP; a cushion assembly comprising a cushion SC and a pad PD coupled to the support LS and movable relative to the base B; the support LS may be configured for movement between an extended position and a retracted position; the support LS and the cushion SC and the pad PD may be configured to provide a deformable support surface for the occupant.

According to an exemplary embodiment as shown schematically in FIGS. 2A-2B, 3, 4, 5A-5D, 6A-6D, 7A-7B, 8A-8B, 10, 17A-17B, 18A-18B, 19A-19D and 20A-20C, the seat assembly ST configured to provide a seat for an occupant of a vehicle may comprise a base B comprising a frame FR; a support LS coupled to the frame FR comprising a spring element SP; a cushion SC supported by the frame FR; and a pad PD coupled to the support LS and movable relative to the base B; the support LS may be configured for movement of the pad PD between an extended position and a retracted position; a cushion assembly may comprise the cushion SC and the pad PD.

According to an exemplary embodiment as shown schematically in FIGS. 2A-2B, 3, 4, 5A-5D, 6A-6D, 7A-7B, 8A-8B, 10, 17A-17B, 18A-18B, 19A-19D and 20A-20C, the seat assembly ST configured to provide a seat for an occupant of a vehicle may comprise a base B comprising a frame FR; a seat back BK coupled to the base B; a support LS coupled to the frame FR comprising a spring element SP; a cushion assembly comprising a cushion SC supported by the frame FR; and a pad PD coupled to the support LS and movable relative to the base B; the support LS may be configured for movement of the pad PD between an extended position and a retracted position.

According to an exemplary embodiment as shown schematically in FIGS. 2A-2B, 3, 4, 5A-5D, 6A-6D, 7A-7B, 8A-8B, 10, 17A-17B, 18A-18B, 19A-19D and 20A-20C, the seat assembly ST configured to provide a for an occupant of a vehicle may comprise a base B comprising a frame FR; a seat back BK coupled to the base B; a support LS coupled to the frame FR comprising a spring element SP; a cushion assembly comprising a cushion SC and a pad PD coupled to the support LS and movable relative to the base B; the support LS may be configured for movement between an extended position and a retracted position; the cushion assembly comprising the cushion SC and the pad PD may be configured to provide a deformable support surface for the occupant.

According to an exemplary embodiment as shown schematically in FIGS. 2A-2B, 3, 4, 5A-5D, 6A-6D, 7A-7B, 8A-8B, 10, 17A-17B, 18A-18B, 19A-19D and 20A-20C, the seat assembly ST configured to provide a seat for an occupant of a vehicle may comprise a base B comprising a frame FR; a support LS coupled to the frame FR comprising a spring element SP; a cushion assembly comprising a cushion SC and a pad PD coupled to the support LS and movable relative to the base B; the support LS may be configured for movement between an extended position and a retracted position; the support LS and the cushion SC and the pad PD may be configured to provide a deformable support surface for the occupant. Sec FIGS. 2A-2B, 3, 4, 5A-5D, 6A-6D, 7A-7B, 8A-8B and 18A-18B.

According to an exemplary embodiment as shown schematically in FIGS. 2A-2B, 3, 4, 5A-5D, 6A-6D, 7A-7B, 8A-8B, 10, 17A-17B, 18A-18B, 19A-19D and 20A-20C, a seat assembly/seat for a vehicle may comprise a back assembly and a cushion assembly; the cushion assembly may comprise a cushion frame and a support. The support may be configured to move between a retracted position and an extended position. The support may comprise a top end coupled to a top side of the cushion frame and a bottom end coupled to a bottom side of cushion frame. When the support moves between the retracted position and the extended position the support may be configured to pivot about at least one of (a) the top end of the support; (b) the bottom end of the support. The support may be configured to deform as the support pivots about the at least one of (a) the top end of the support; (b) the bottom end of the support. The top end of the support may be fixed to the top side of the cushion frame to prevent translation of the top end of the support; the bottom end of the support may be fixed to the bottom side of cushion frame to prevent translation of the bottom end of the support. The support may be biased in the extended position. The support may be at least one of (a) stressed in the extended position; (b) loaded in the extended position. The support may be at least one of (a) stressed in the retracted position; (b) loaded in the retracted position. When the support is assembled to the cushion frame, the support may be at least one of (a) pre-stressed; (b) pre-loaded. The support may be configured to increase a seating surface area in movement from the retracted position to the extended position. The support may be configured to rotate about the cushion frame. The support may comprise a fulcrum; the fulcrum may be configured to shift as the support moves between the extended position and the retracted position. The support may comprise at least one of (a) compliant panel; (b) a deformable panel. The support may comprise a TPE material. The support may comprise a spring comprising a first end coupled to a top side of the cushion frame and a second end coupled to a bottom side of cushion frame. The spring may be wound about the cushion frame when installed to the cushion frame. The support may comprise a spring coupled to a panel. The panel may be molded on the spring. The seat may comprise a mechanism configured to adjust the support. The mechanism may comprise at least one of (a) a cable mechanism; (b) an actuator; (c) an actuator configured to pull a cable to straighten the support. The seat may comprise a pad. The pad may be configured to move relative to the cushion as the support moves between the retracted position and the extended position. The cushion may be fixed to the cushion frame; the pad may be configured to move above the cushion relative to the cushion frame as the support moves between the retracted position and the extended position. The seat may comprise a spring between the cushion and the pad. The seat may comprise at least one of (a) a panel between the cushion and the pad; (b) a suspension mat between the cushion and the pad. The seat may comprise a spring and a flexible panel between the cushion and the pad.

### Exemplary Embodiments—B

According to an exemplary embodiment as shown schematically in FIGS. 2A-2B, 3, 4, 5A-5D, 6A-6D, 7A-7B, 8A-8B, 10, 17A-17B, 18A-18B, 19A-19D and 20A-20C, a seat assembly for an occupant of a vehicle may comprise a base comprising a frame; a support coupled to the frame comprising a spring element; a cushion; and a pad coupled to the support and movable relative to the base. The support may be configured for movement between an extended position and a retracted position. The cushion and the pad may be configured to provide a deformable support surface for the occupant.

According to an exemplary embodiment as shown schematically in FIGS. 2A-2B, 3, 4, 5A-5D, 6A-6D, 7A-7B, 8A-8B, 10, 17A-17B, 18A-18B, 19A-19D and 20A-20C, the extended position may comprise a default position for the support. The support with the cushion and the pad may be configured to provide a deformable support surface for the occupant. The cushion may be coupled to the frame. The cushion may be configured to provide a fulcrum for the support. The cushion may be configured to provide a support structure for the spring element of the support. The pad may be configured to be supported by the support. The pad may be configured to be supported by the spring element of the support. The pad may be configured to be extended from the base when the support is in the extended position. The pad may be configured to be retracted toward the base when the support is in the retracted position. The extended position may comprise a default position for the pad. The spring element may be configured to be wound to move the support toward the retracted position. The spring element may be configured to be unwound to move the support toward the extended position. The spring element may be configured to be pulled toward the retracted position. The support may be configured to deflect to support the occupant. The spring element may be configured to deflect. The support may be configured to facilitate deflection of the pad. The support may be configured to facilitate flexure of the pad. The support may be configured to reduce bending of the pad.

According to an exemplary embodiment as shown schematically in FIGS. 2A-2B, 3, 4, 5A-5D, 6A-6D, 7A-7B, 8A-8B, 10, 17A-17B, 18A-18B, 19A-19D and 20A-20C, the deformable support surface may comprise a reactive surface configured to support the occupant. The support may be configured to provide the reactive surface configured to support the occupant. The support may be configured to provide a reactive surface configured to provide a reactive force to support the occupant. The support may be configured to provide a reactive surface configured to provide a distributed reactive force to support the occupant. The support may be configured to communicate a reactive force configured to support the occupant. The support may be configured to communicate a reactive force through the pad configured to support the occupant. The support may be configured to communicate a reactive force through the cushion configured to support the occupant. The support may be configured to provide a reactive surface configured to deflect to provide a reactive force to support the occupant. The support may be configured to provide a reactive surface configured to deflect to provide a reactive force to support the occupant. The support may be configured to provide a reactive surface configured to deflect to provide a reactive force with varying contact pressure to support the occupant. The reactive surface may be provided by the spring element and the cushion and the pad. The support may be configured to provide a reactive surface configured to deflect to provide a reactive force to support the occupant; the cushion may be configured to provide shape control for the reactive surface. The deformable support surface may comprise a compound support surface configured to support the occupant. The compound support surface may comprise the support with the cushion and the pad. The compound support surface may comprise the support with the cushion and the pad to provide a variable pressure distribution. The compound support surface may comprise the support with the cushion and the pad to provide a variable pressure distribution by variation of the shape of the support. The compound support surface may comprise the support with the cushion and the pad to provide a variable pressure distribution by variation of the shape of the support with an adjuster. The compound support surface may comprise the support with the cushion and the pad to provide a variable pressure distribution by variation of the shape of the support with an adjuster comprising an operator control and a mechanism. The compound support surface may comprise the support with the cushion and the pad to provide a selectable pressure distribution by selective variation of the shape of the support with an adjuster comprising an operator control and a mechanism. The reactive surface may comprise an extended shape and a retracted shape. The reactive surface may be in the extended shape when the support is in the extended position. The reactive surface may be in the retracted shape when the support is in the retracted position. The reactive surface may be in the extended shape when the pad is in an extended position. The reactive surface may be in the retracted shape when the pad is in a retracted position. The reactive surface may be moved toward the retracted shape when the support is moved toward the retracted position. The reactive surface may be moved toward the retracted shape when the support is moved toward the retracted position by movement of the spring element. The reactive surface may be moved toward the retracted shape when the support is moved toward the retracted position by winding of the spring element. The reactive surface may be rolled toward the extended shape when the support is moved toward the extended position by unwinding of the spring element.

According to an exemplary embodiment as shown schematically in FIGS. 2A-2B, 3, 4, 5A-5D, 6A-6D, 7A-7B, 8A-8B, 10, 17A-17B, 18A-18B, 19A-19D and 20A-20C, the spring element may comprise a flexible panel. The flexible panel may comprise a sheet spring. The spring element may comprise a sheet spring. The spring element may comprise a curved sheet spring. The spring element may comprise a curved sheet. The spring element may comprise a formed curved sheet. The spring element may comprise a curved form. The spring element may comprise a curved shape. The spring element may comprise a pre-form shape. The spring element may comprise a spring member. The spring element may comprise a set of spring members. The spring element may comprise a spring. The spring element may comprise a spring strip. The spring element may comprise a segmented spring element.

According to an exemplary embodiment as shown schematically in FIGS. 2A-2B, 3, 4, 5A-5D, 6A-6D, 7A-7B, 8A-8B, 10, 17A-17B, 18A-18B, 19A-19D and 20A-20C, the support may comprise a feature. The spring element may comprise a feature. The feature may comprise a stiffener. The feature may comprise a set of features. The feature may comprise a set of stiffeners. The feature may comprise a set of recesses. The feature may comprise a set of transverse recesses. The feature may comprise a set of transverse recesses of varying length. The feature may comprise a set of ribs. The feature may comprise a set of ribs of varying length. The feature may comprise a set of transverse ribs of varying length. The feature may be configured to provide a stiffness of the spring element. The feature may be configured to provide a spring force for the spring element. The feature may comprise a set of features configured to provide a spring force for the spring element. The feature may comprise a recess. The feature may comprise a recess at a front end. The feature may comprise a recess configured to facilitate deflection of the spring element. The feature may comprise a set of stiffeners and a recess. The feature may comprise an attachment for a cover material.

According to an exemplary embodiment as shown schematically in FIGS. 2A-2B, 3, 4, 5A-5D, 6A-6D, 7A-7B, 8A-8B, 10, 17A-17B, 18A-18B, 19A-19D and 20A-20C, the spring element may comprise a wedge shape. The spring element may comprise a resin material. The spring element may comprise a metal element. The spring element may comprise a TPE material. The spring element may comprise a substrate. The spring element may comprise the substrate and a set of springs. The set of springs may comprise a set of spring strips. The support may be provided in an extended position when the spring element is in a default state. The support may be configured to be moved toward the retracted position by movement of the spring element. The support may be configured to be moved toward the retracted position by winding the spring element. The support may be configured to be moved toward the extended position by movement of the spring element. The support may be configured to be moved toward the extended position by unwinding the spring element. The support may be provided in the extended position with the spring element moved toward an unwound state. The support may be configured to move toward the retracted position with the spring element moved toward a wound state.

According to an exemplary embodiment as shown schematically in FIGS. 2A-2B, 3, 4, 5A-5D, 6A-6D, 7A-7B, 8A-8B, 10, 17A-17B, 18A-18B, 19A-19D and 20A-20C, the seat assembly may comprise a cushion assembly comprising the cushion and the pad. The cushion and pad may be configured to provide an interface within the cushion assembly. The pad may be configured to fit with the cushion at the interface. A surface of the pad may be configured to fit with a surface of the cushion at the interface. The support may be configured to support the cushion assembly. The spring element may be within the cushion assembly. The frame may comprise a cushion frame. The cushion frame may be configured to support the cushion assembly. The frame may comprise a pan. The support may be within the frame. The cushion may comprise a base pad. The support may be coupled to the frame. The support may comprise the spring element and a set of mounting brackets. The support may be connected to the frame at the set of mounting brackets. The support may comprise a base end and a front end. The spring element of the support may be configured to be supported at a base end and a front end. The support may be coupled to the frame by a set of tabs. The support may be coupled to the frame by a clip arrangement. The spring element of the support may be coupled to the frame by a clip arrangement. The spring element may be coupled to the frame. The spring element may be coupled to the frame by a bracket. The spring element may be coupled to the frame by a mounting flange. The spring element may be coupled to the frame by a clip. The spring element may be coupled to the frame by a hook. The spring element may comprise a base end and front end. The base end of the spring element may be coupled to the frame. The front end of the spring element may be coupled to the frame. The front end of the spring element may be coupled to the frame by a clip. The front end of the spring element may be pivotally coupled to the frame by a clip. The front end of the spring element may be pivotally coupled to the frame at a hinge. The base end of the spring element may be coupled to the frame by a bracket. The base end of the spring element may be coupled to the frame by a mounting flange. The support may comprise a beam support. The beam support may be supported at a base end and a front end. The support may comprise a fulcrum. The support may comprise a fulcrum within the cushion. The support may comprise a fulcrum between a base end and a front end. The support may comprise a fulcrum for the spring element between the base end and the front end. The fulcrum may comprise a support point for the spring element. The cushion and pad may be configured to provide an interface. The interface may be provided adjacent to a fulcrum for the spring element. The cushion may be configured to compress adjacent to the fulcrum. The cushion may be configured to provide a stop for the support. The cushion may be configured to provide a shape control for the support. The cushion may be configured to provide a shape control under the spring element of the support. The pad may be configured to deflect adjacent to the fulcrum. The pad may be configured to cover the spring element. The pad may be at least partially wrapped onto the spring element. The cushion may comprise a foam pad. The pad may comprise a foam pad. The pad may comprise a continuous foam pad.

According to an exemplary embodiment as shown schematically in FIGS. 2A-2B, 3, 4, 5A-5D, 6A-6D, 7A-7B, 8A-8B, 10, 17A-17B, 18A-18B, 19A-19D and 20A-20C, the support may comprise an extender. The support may comprise a cushion extender. The support may comprise a leg support.

According to an exemplary embodiment as shown schematically in FIGS. 2A-2B, 3, 4, 5A-5D, 6A-6D, 7A-7B, 8A-8B, 10, 17A-17B, 18A-18B, 19A-19D and 20A-20C, the support may comprise a deformable support. The support may comprise a support frame coupled to the frame of the base. The support may comprise a cantilever structure. The spring element of the support may be configured to be supported at a base end and a front end. The spring element may be provided in a shape. The shape may comprise a curved shape. The shape may comprise a partially wound shape. The shape may comprise a partially unwound shape. The shape may comprise a default shape; the default shape may comprise the partially unwound shape. The spring element may be configured to be pulled from the partially unwound shape toward the partially wound shape.

According to an exemplary embodiment as shown schematically in FIGS. 2A-2B, 3, 4, 5A-5D, 6A-6D, 7A-7B, 8A-8B, 10, 17A-17B, 18A-18B, 19A-19D and 20A-20C, the seat assembly may comprise a mechanism configured to alter the shape of the spring element. The seat assembly may comprise a mechanism configured to alter the shape of the spring element between a partially unwound shape and a partially wound shape. The shape of the spring element may comprise a curved shape; the seat assembly may comprise a mechanism configured to alter the curved shape of the spring element between a partially unwound shape and a partially wound shape. The seat assembly may comprise a mechanism configured to move the support toward the retracted position. The seat assembly may comprise a mechanism configured to wind the spring element toward the retracted position. The seat assembly may comprise a mechanism configured to unwind the spring element toward the extended position. The seat assembly may comprise a mechanism configured to move the support between a retracted position and an extended position by altering the shape of the spring element. The seat assembly may comprise a mechanism configured to move the support between a retracted position and an extended position by altering the shape of the spring element. The seat assembly may comprise a mechanism configured to move the support toward an extended position. The seat assembly may comprise a mechanism configured to move the support between a retracted position and an extended position. The seat assembly may comprise a mechanism configured to move the support toward an extended position. The seat assembly may comprise an operator control for the mechanism. The mechanism may comprise a cable drive mechanism. The mechanism may comprise a cable coupled to the support. The mechanism may comprise an actuator. The actuator may comprise a motor. The actuator may comprise a drive mechanism. The actuator may comprise a screw drive. The mechanism may comprise a cable with a plug coupled to the support; the cable may be configured to move the support toward a retracted position. The cable may be configured to pull the spring element toward a retracted position. The spring element may be provided in an extended position. The spring element may be provided in an extended position; the mechanism may be configured to move the spring element toward the retracted position. The spring element may be provided in an extended position; the mechanism may be configured to wind the spring element toward the retracted position. The spring element may be provided in an extended position; the mechanism may be configured to unwind the spring element toward the extended position. The base may comprise a chassis. The chassis may be configured to be movable on a track system.

According to an exemplary embodiment as shown schematically in FIGS. 2A-2B, 3, 4, 5A-5D, 6A-6D, 7A-7B, 8A-8B, 10, 17A-17B, 18A-18B, 19A-19D and 20A-20C, a seat for a vehicle may comprise a back assembly and a cushion assembly. The cushion assembly may comprise a cushion frame and a support. The support may be configured to move between a retracted position and an extended position. The support may comprise a top end coupled to a top side of the cushion frame and a bottom end coupled to a bottom side of cushion frame. When the support moves between the retracted position and the extended position the support may be configured to pivot about at least one of (a) the top end of the support; (b) the bottom end of the support. The support may be configured to deform as the support pivots about the at least one of (a) the top end of the support; (b) the bottom end of the support. The top end of the support is fixed to the top side of the cushion frame to prevent translation of the top end of the support; the bottom end of the support is fixed to the bottom side of cushion frame to prevent translation of the bottom end of the support. The support may be biased in the extended position. The support may be at least one of (a) stressed in the extended position; (b) loaded in the extended position. The support may be at least one of (a) stressed in the retracted position; (b) loaded in the retracted position. When the support is assembled to the cushion frame, the support is at least one of (a) pre-stressed; (b) pre-loaded. The support may be configured to increase a seating surface area in movement from the retracted position to the extended position. The support may be configured to rotate about the cushion frame. The support may comprise a first shape when in the retracted position and a second shape when in the extended position. The first shape may comprise a first arc length and the second shape may comprise a second arc length greater than the first arc length. The first shape may comprise a curved shape; the second shape may comprise a straightened shape. The first shape may conform to a shape of the cushion frame. The first shape may comprise a wound shape and the second shape may comprise an unwound shape. The first shape may extend forward of the cushion frame; the second shape may be tucked under the cushion frame. The retracted position may comprise a lowered position and the extended position may comprise a raised position. The support may be configured to raise in movement from the retracted position to the extended position. The support may be configured to collapse in movement from the extended position to the retracted position. The support may be configured to provide a first thigh angle when in the retracted position and a second thigh angle when in the extended position. The second thigh angle may be greater than the first thigh angle. The support may be configured to provide a first cushion exit point when in the retracted position and a second cushion exit point when in the extended position. The support may be configured to wrap around the cushion frame. The support may comprise a cantilever relative to the cushion frame. The cushion frame may comprise a stop. The support may be configured to deflect against the stop. The support may be configured to wrap around the stop when in the retracted position. The support may be configured to flex when the seat is occupied. The support may be configured to apply a tensile force to the cushion frame when the support is in the extended position and the seat is occupied. The support may be configured to apply a compressive force to the cushion frame when the support is in the retracted position and the seat is occupied. The support may comprise a fulcrum; the fulcrum may be configured to shift as the support moves between the extended position and the retracted position. The support may comprise a compliant panel. The support may comprise a deformable panel. The support may comprise a TPE material. The support may comprise a spring comprising a first end coupled to a top side of the cushion frame and a second end coupled to a bottom side of cushion frame. The spring may be wound about the cushion frame when installed to the cushion frame. The spring may comprise a set of springs. The spring may comprise a spring steel material. The spring may be configured to wind and unwind. The seat may comprise a cable configured to at least one of (a) deform the spring; (b) pull the spring to move the support toward the retracted position. The cable may be coupled to the spring below the cushion frame between the first end of the spring and the second end of the spring. The seat may comprise a cable configured to provide a force to the spring (a) to pivot the first end relative to the cushion frame and (b) to pivot the second end relative to the cushion frame. The support may comprise a spring coupled to a panel. The panel may be molded on the spring. The seat may comprise a mechanism configured to adjust the support. The mechanism may comprise a cable mechanism. The mechanism may comprise an actuator. The actuator may be configured to pull a cable to move the support toward the extended position. The actuator may be configured to pull a cable to straighten the support. The actuator may comprise a screw drive. The actuator may comprise a motor. The seat may comprise a pad. The pad may comprise a foam. The pad may be configured to move relative to the cushion as the support moves between the retracted position and the extended position. The cushion may be fixed to the cushion frame; the pad may be configured to move above the cushion relative to the cushion frame as the support moves between the retracted position and the extended position. The seat may comprise a spring between the cushion and the pad. The seat may comprise at least one of (a) a panel between the cushion and the pad; (b) a suspension mat between the cushion and the pad. The seat may comprise a spring and a flexible panel between the cushion and the pad.

### Exemplary Embodiments—C

According to an exemplary embodiment as shown schematically in the FIGURES, a seat for a vehicle may comprise a back and a cushion. The cushion may comprise a cushion frame and a leg support. The leg support may be configured to move between a retracted position and an extended position as shown schematically. The leg support may comprise a top end coupled to a top side of the cushion frame and a bottom end coupled to a bottom side of cushion frame. When the leg support moves between the retracted position and the extended position the leg support may be configured to pivot about at least one of (a) the top end of the leg support; (b) the bottom end of the leg support. The leg support may be configured to deform as the leg support pivots about the at least one of (a) the top end of the leg support; (b) the bottom end of the leg support. The top end of the leg support may be fixed to the top side of the cushion frame to prevent translation of the top end of the leg support; the bottom end of the leg support may be fixed to the bottom side of cushion frame to prevent translation of the bottom end of the leg support. The leg support may be biased in the extended position. The leg support may be at least one of (a) stressed in the extended position; (b) loaded in the extended position. The leg support may be at least one of (a) stressed in the retracted position; (b) loaded in the retracted position. When the leg support is assembled to the cushion frame, the leg support may be at least one of (a) pre-stressed; (b) pre-loaded. The leg support may be configured to increase a seating surface area in movement from the retracted position to the extended position. The leg support may be configured to rotate about the cushion frame as shown schematically. The leg support may comprise a first shape when in the retracted position and a second shape when in the extended position. The first shape may comprise a first arc length and the second shape may comprise a second arc length greater than the first arc length. The first shape may comprise a curved shape; the second shape may comprise a straightened shape. The first shape may conform to a shape of the cushion frame. The first shape may comprise a wound shape and the second shape may comprise an unwound shape. The first shape may extend forward of the cushion frame; the second shape may be tucked under the cushion frame. The retracted position may comprise a lowered position and the extended position may comprise a raised position. The leg support may be configured to raise in movement from the retracted position to the extended position. The leg support may be configured to collapse in movement from the extended position to the retracted position. The leg support may be configured to provide a first thigh angle when in the retracted position and a second thigh angle when in the extended position. The second thigh angle may be greater than the first thigh angle. The leg support may be configured to provide a first cushion exit point when in the retracted position and a second cushion exit point when in the extended position. The leg support may be configured to wrap around the cushion frame. The leg support may comprise a cantilever relative to the cushion frame. The cushion frame may comprise a stop. The leg support may be configured to deflect against the stop. The leg support may be configured to wrap around the stop when in the retracted position. The leg support may be configured to flex when the seat is occupied. The leg support may be configured to apply a tensile force to the cushion frame when the leg support is in the extended position and the seat is occupied. The leg support may be configured to apply a compressive force to the cushion frame when the leg support is in the retracted position and the seat is occupied. The leg support may comprise a fulcrum; the fulcrum may be configured to shift as the leg support moves between the extended position and the retracted position. The leg support may comprise a compliant panel. The leg support may comprise a deformable panel. The leg support may comprise a TPE material. The leg support may comprise a spring comprising a first end coupled to a top side of the cushion frame and a second end coupled to a bottom side of cushion frame. The spring may be wound about the cushion frame when installed to the cushion frame. The spring may comprise a set of springs. The spring may comprise a spring steel material. The spring may be configured to wind and unwind. The seat may comprise a cable configured to at least one of (a) deform the spring; (b) pull the spring to move the leg support toward the retracted position. The cable may be coupled to the spring below the cushion frame between the first end of the spring and the second end of the spring. The seat may comprise a cable configured to provide a force to the spring (a) to pivot the first end relative to the cushion frame and (b) to pivot the second end relative to the cushion frame The leg support may comprise a spring coupled to a panel. The panel may be molded on the spring. The seat may comprise a mechanism configured to adjust the leg support. The mechanism may comprise a cable mechanism. The mechanism may comprise an actuator. The actuator may be configured to pull a cable to move the leg support toward the extended position. The actuator may be configured to pull a cable to straighten the leg support. The actuator may comprise a screw drive. The actuator may comprise a motor. The seat may comprise a pad. The pad may comprise a foam. The pad may comprise a body and a flap. The flap may be configured to move relative to the body as the leg support moves between the retracted position and the extended position. The body may be fixed to the cushion frame; the flap may be configured to move above the body relative to the cushion frame as the leg support moves between the retracted position and the extended position. The seat may comprise a spring between the body and the flap. The seat may comprise at least one of (a) a panel between the body and the flap; (b) a suspension mat between the body and the flap. The seat may comprise a spring and a flexible panel between the body and the flap.

### Exemplary Embodiments—D

According to an exemplary embodiment as shown schematically in the FIGURES, a seat for a vehicle may comprise a back and a cushion. The cushion may comprise a cushion frame and a leg support. The leg support may be configured to move between a retracted position and an extended position as shown schematically. The leg support may comprise a top end coupled to a top side of the cushion frame and a bottom end coupled to a bottom side of cushion frame. When the leg support moves between the retracted position and the extended position the leg support may be configured to pivot about at least one of (a) the top end of the leg support; (b) the bottom end of the leg support. The leg support may be configured to deform as the leg support pivots about the at least one of (a) the top end of the leg support; (b) the bottom end of the leg support. The top end of the leg support may be fixed to the top side of the cushion frame to prevent translation of the top end of the leg support; the bottom end of the leg support may be fixed to the bottom side of cushion frame to prevent translation of the bottom end of the leg support. The leg support may be biased in the extended position. The leg support may be at least one of (a) stressed in the extended position; (b) loaded in the extended position. The leg support may be at least one of (a) stressed in the retracted position; (b) loaded in the retracted position. When the leg support is assembled to the cushion frame, the leg support may be at least one of (a) pre-stressed; (b) pre-loaded. The leg support may be configured to increase a seating surface area in movement from the retracted position to the extended position. The leg support may be configured to rotate about the cushion frame as shown schematically. The leg support may comprise a first shape when in the retracted position and a second shape when in the extended position. The first shape may comprise a first arc length and the second shape may comprise a second arc length greater than the first arc length. The first shape may comprise a curved shape; the second shape may comprise a straightened shape. The first shape may conform to a shape of the cushion frame. The first shape may comprise a wound shape and the second shape may comprise an unwound shape. The first shape may extend forward of the cushion frame; the second shape may be tucked under the cushion frame. The retracted position may comprise a lowered position and the extended position may comprise a raised position. The leg support may be configured to raise in movement from the retracted position to the extended position. The leg support may be configured to collapse in movement from the extended position to the retracted position. The leg support may be configured to provide a first thigh angle when in the retracted position and a second thigh angle when in the extended position. The second thigh angle may be greater than the first thigh angle. The leg support may be configured to provide a first cushion exit point when in the retracted position and a second cushion exit point when in the extended position. The leg support may be configured to wrap around the cushion frame. The leg support may comprise a cantilever relative to the cushion frame. The cushion frame may comprise a stop. The leg support may be configured to deflect against the stop. The leg support may be configured to wrap around the stop when in the retracted position. The leg support may be configured to flex when the seat is occupied. The leg support may be configured to apply a tensile force to the cushion frame when the leg support is in the extended position and the seat is occupied. The leg support may be configured to apply a compressive force to the cushion frame when the leg support is in the retracted position and the seat is occupied. The leg support may comprise a fulcrum; the fulcrum may be configured to shift as the leg support moves between the extended position and the retracted position. The leg support may comprise a compliant panel. The leg support may comprise a deformable panel. The leg support may comprise a TPE material. The leg support may comprise a spring comprising a first end coupled to a top side of the cushion frame and a second end coupled to a bottom side of cushion frame. The spring may be wound about the cushion frame when installed to the cushion frame. The spring may comprise a set of springs. The spring may comprise a spring steel material. The spring may be configured to wind and unwind. The seat may comprise a cable configured to at least one of (a) deform the spring; (b) pull the spring to move the leg support toward the retracted position. The cable may be coupled to the spring below the cushion frame between the first end of the spring and the second end of the spring. The seat may comprise a cable configured to provide a force to the spring (a) to pivot the first end relative to the cushion frame and (b) to pivot the second end relative to the cushion frame. The leg support may comprise a spring coupled to a panel. The panel may be molded on the spring. The seat may comprise a mechanism configured to adjust the leg support. The mechanism may comprise a cable mechanism. The mechanism may comprise an actuator. The actuator may be configured to pull a cable to move the leg support toward the extended position. The actuator may be configured to pull a cable to straighten the leg support. The actuator may comprise a screw drive. The actuator may comprise a motor. The seat may comprise a pad. The pad may comprise a foam. The pad may comprise a body and a flap. The flap may be configured to move relative to the body as the leg support moves between the retracted position and the extended position. The body may be fixed to the cushion frame; the flap may be configured to move above the body relative to the cushion frame as the leg support moves between the retracted position and the extended position. The seat may comprise a spring between the body and the flap. The seat may comprise at least one of (a) a panel between the body and the flap; (b) a suspension mat between the body and the flap. The seat may comprise a spring and a flexible panel between the body and the flap

TABLE A
REFERENCE SYMBOL LIST

| REFERENCE | |
|---|---|
| SYMBOL | ELEMENT, PART OR COMPONENT |
| V | vehicle |
| I | interior |
| VP | vehicle occupant |
| ST | seat assembly/seat |
| B | base (with chassis and track assembly) |
| BK | back |
| SC | cushion/body |
| PD | pad/flap |
| FR | frame/cushion frame |
| LS | support |
| SP | spring element |
| SG | spring |
| SB | substrate |
| PN | panel/flexible panel |
| BR | bracket/mounting flange (with hook/clip) |
| FT | feature |
| FT/RC | feature/recess |
| FT/HT | feature/attachment feature |
| FT/FNL | feature/structural element/member |
| FT/FNS | (e.g. stiffener, stiffness adjusting element, etc.) |
| FT/FN | |
| M | mechanism |
| MC | mechanism/operator control |
| A | actuator |
| C | cable |
| PG | tip end/plug/barrel |
| FG | fitting/clip |
| MT | motor |

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

The invention claimed is:

1. A seat assembly for an occupant of a vehicle comprising:
a base comprising a frame;
a support coupled to the frame comprising a spring element;
a cushion; and
a pad on the support and movable relative to the base;
wherein the support is configured for movement between an extended position and a retracted position;
wherein the cushion and the pad are configured to provide a deformable support surface for the occupant;
wherein the pad is configured to be supported by the spring element of the support;
wherein the pad is configured to be extended from the base when the support is in the extended position;
wherein the pad is configured to be retracted toward the base when the support is in the retracted position.

2. The seat assembly of claim 1 wherein the support is configured to increase a seating surface area in movement from the retracted position to the extended position.

3. The seat assembly of claim 1 wherein the spring element is configured to be wound to move the support toward the retracted position; wherein the spring element is configured to be unwound to move the support toward the extended position.

4. The seat assembly of claim 1 wherein the support is configured to increase a seating surface area in movement from the retracted position to the extended position; wherein the deformable support surface is configured to provide a variable pressure distribution by variation of the seating surface area.

5. The seat assembly of claim 1 wherein the support comprises a fulcrum; wherein the fulcrum is configured to shift as the support moves between the extended position and the retracted position.

6. The seat assembly of claim 1 wherein the deformable support surface comprises a reactive surface configured to support the occupant; wherein the support is configured to communicate a reactive force through the pad and/or the cushion configured to support the occupant.

7. The seat assembly of claim 1 wherein the support is configured provide a reactive surface configured to deflect to provide a reactive force with varying contact pressure to support the occupant; wherein the reactive surface is provided by the spring element and the cushion and the pad; wherein the cushion is configured to provide shape control for the reactive surface.

8. The seat assembly of claim 7 wherein the reactive surface is in the extended shape when the pad is in an extended position; wherein the reactive surface is in the retracted shape when the pad is in a retracted position; wherein the reactive surface is moved toward the retracted shape when the support is moved toward the retracted position by movement of the spring element.

9. The seat assembly of claim 1 wherein the pad is configured to move relative to the cushion as the support moves between the retracted position and the extended position.

10. The seat assembly of claim 1 wherein the spring element comprises a flexible panel.

11. The seat assembly of claim 1 wherein the spring element comprises at least one of (a) a curved sheet spring and/or a curved sheet and/or a formed curved sheet; (b) a curved form and/or a curved shape and/or a pre-form shape; (c) a spring member and/or a spring strip and/or a segmented spring element; (d) a spring as a flexible panel between the cushion and the pad.

12. The seat assembly of claim 1 wherein the spring element comprises a feature; wherein the feature comprises at least one of (a) a stiffener; (b) a set of features; (c) a set of stiffeners; (d) a set of recesses; (e) a set of transverse recesses; (f) a set of transverse recesses of varying length; (g) a set of ribs; (h) a set of ribs of varying length;. (i) a set of transverse ribs of varying length; (j) a feature configured to provide a stiffness of the spring element; (k) a set of features configured to provide a spring force for the spring element; (l) at least one of a recess and/or a recess at a front end and/or a recess configured to facilitate deflection of the spring element; (m) a set of stiffeners and a recess; (n) an attachment for a cover material.

13. The seat assembly of claim 1 wherein the spring element comprises at least one of (a) a resin material; (b) a metal element; (c) a TPE material; (d) a substrate and a set of spring strips; (e) a wedge shape; (f) an elastomeric material; (g) a flexible panel; (h) a flexible panel comprising an elastomer; (i) a semi-rigid deformable flexible panel.

14. The seat assembly of claim 1 further comprising a cushion assembly comprising the cushion and the pad; wherein the support is configured to support the cushion assembly; wherein the spring element is within the cushion assembly; wherein the frame comprises a cushion frame configured to support the cushion assembly;.

15. The seat assembly of claim 1 wherein the pad is at least partially coupled onto the spring element.

16. The seat assembly of claim 1 wherein the spring element is provided in a default shape; wherein the default shape comprises a partially unwound shape; wherein the spring element is configured to be moved from the partially unwound shape toward a partially wound shape.

17. The seat assembly of claim 1 wherein a shape of the spring element comprises a partially curved shape; further comprising a mechanism configured to alter the partially curved shape of the spring element between a partially extended shape and a partially retracted shape.

18. The seat assembly of claim 1 wherein the support comprises a spring comprising a first end coupled to a top side of the cushion frame and a second end coupled to a bottom side of cushion frame.

19. The seat assembly of claim 1 wherein the spring element comprises a base end and front end; wherein the base end of the spring element is coupled to the frame; wherein the front end of the spring element is coupled to the frame; wherein the support comprises a beam support supported at a base end and a front end.

20. The seat assembly of claim 1 further comprising a mechanism configured to adjust the support; wherein the mechanism comprises at least one of (a) a cable mechanism; (b) a cable drive mechanism; (c) an actuator; (d) a motor; (e) a drive mechanism comprising an actuator; (f) an actuator configured to pull a cable to straighten the support; (g) a mechanism configured to move the support between the retracted position and the extended position; (h) a actuator configured to move the support between the retracted position and the extended position; (i) a mechanism configured to move the support toward the retracted position; (j) a mechanism configured to wind the spring element toward the retracted position and to unwind the spring element toward the extended position; (k) a mechanism configured to move the support between a retracted position and an extended position by altering the shape of the spring element; (l) a mechanism configured to alter the curved shape of the spring element between a partially unwound shape and a partially wound shape.
